(19) United States
(12) Patent Application Publication
(10) Pub. No.: US 2026/0246593 A1
(43) Pub. Date: Aug. 20, 2026

(54) UNIFIED CORESET DESIGN WITH MULTIPLE CONFIGURATIONS

(71) Applicant: Samsung Electronics Co., Ltd., Suwon-si (KR)

(72) Inventors: Emad Nader Farag, Flanders, NJ (US); Aristides Papasakellariou, Houston, TX (US); Marian Rudolf, Longueuil (CA); Hongbo Si, Allen, TX (US); Ebrahim MolavianJazi, San Jose, CA (US)

(21) Appl. No.: 19/534,142

(22) Filed: Feb. 9, 2026

Related U.S. Application Data
(60) Provisional application No. 63/761,020, filed on Feb. 20, 2025.

(51) Int. Cl. H04L 5/00; H04W 72/1273

(52) U.S. Cl. CPC H04L 5/0053; H04W 72/1273

(57) ABSTRACT

Apparatuses and methods for a unified control resource set (CORESET) design with multiple configurations. A method performed by a user equipment includes receiving configuration information related to a CORESET. The configuration information includes a first pattern and a second pattern. The first pattern spans

$${N}_{symb 1}^{CORESET}$$

symbols and

$${N}_{RB 1}^{CORESET}$$

resource blocks (RBs). The second pattern spans

$${N}_{s y m b 2}^{CORESET}$$

symbols and

$${N}_{R B 2}^{CORESET}$$

RBs. The first pattern and the second pattern overlaps over the

$${N}_{s y m b 1}^{CORESET}$$

symbols and the

$${N}_{R B 2}^{CORESET}$$

RBs. The CORESET corresponds to a CORESET zero. The method further includes determining a type of the UE, determining, based on the type of the UE, a pattern from the first pattern and the second pattern, and monitoring a PDCCH in the CORESET based on the determined pattern.

### CROSS-REFERENCE TO RELATED AND CLAIM OF PRIORITY

The present application claims priority under 35 U.S.C. § 119(e) to U.S. Provisional Patent Application No. 63/761,020 filed on Feb. 20, 2025, which is hereby incorporated by reference in their entirety.

### TECHNICAL FIELD

The present disclosure relates generally to wireless communication systems and, more specifically, the present disclosure is related to a unified control resource set (CORESET) design with multiple configurations and a unified common channel design for low bandwidth and high bandwidth user equipment (UEs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a unified CORESET design with multiple configurations and a unified common channel design for low bandwidth and high bandwidth UEs.

In one embodiment, a UE is provided. The UE includes a transceiver configured to receive configuration information related to a CORESET. The configuration information includes a first pattern and a second pattern. The first pattern spans

$${N}_{s y m b 1}^{CORESET}$$

symbols and

$${N}_{R B 1}^{CORESET}$$

resource blocks (RBs). The second pattern spans

$${N}_{s y m b 2}^{CORESET}$$

symbols and

$${N}_{R B 2}^{CORESET}$$

### RBs.

$${N}_{s y m b 1}^{CORESET} < {N}_{s y m b 2}^{CORESET} and {N}_{RB 1}^{CORESET} > {N}_{R B 2}^{CORESET} .$$

The first pattern and the second pattern overlaps over the

$${N}_{s y m b 1}^{C O R E S E T}$$

symbols and the

$${N}_{R B 2}^{C O R E S E T}$$

RBs. The CORSET corresponds to a CORESET zero. The UE further includes a processor operably coupled to the transceiver. The processor configured to determine a type of the UE, determine, based on the type of the UE, a pattern from the first pattern and the second pattern, and monitor a PDCCH in the CORESET based on the determined pattern.

In another embodiment, a base station (BS) is provided. The BS includes a transceiver configured to transmit configuration information related to a CORESET. The configuration information includes a first pattern and a second pattern. The first pattern spans

$${N}_{s y m b 1}^{C O R E S E T}$$

symbols and

$${N}_{R B 1}^{C O R E S E T}$$

RBs. The second pattern spans

$${N}_{s y m b 2}^{C O R E S E T}$$

symbols and

$${N}_{R B 2}^{C O R E S E T}$$

### RBs.

$${N}_{s y m b 1}^{C O R E S E T} < {N}_{s y m b 2}^{C O R E S E T} and {N}_{R B 1}^{C O R E S E T} > {N}_{RB 2}^{CORESET} .$$

The first pattern and the second pattern overlaps over the

$${N}_{s y m b 1}^{C O R E S E T}$$

symbols and the

$${N}_{R B 2}^{CORESET}$$

RBS. The BS further includes a processor operably coupled to the transceiver. The processor is configured to determine a type of the UE and determine, based on the type of the UE, a pattern from the first pattern and the second pattern. The transceiver is further configured to transmit a PDCCH in the CORESET based on the determined pattern.

In yet another embodiment, a method performed by a user equipment is provided. The method includes receiving configuration information related to a CORESET. The configuration information includes a first pattern and a second pattern. The first pattern spans

$${N}_{s y m b 1}^{C O R E S E T}$$

symbols and

$${N}_{R B 1}^{C O R E S E T}$$

RBs. The second pattern spans

$${N}_{s y m b 2}^{C O R E S E T}$$

symbols and

$${N}_{R B 2}^{C O R E S E T}$$

### RBs.

$${N}_{s y m b 1}^{C O R E S E T} < {N}_{s y m b 2}^{C O R E S E T} and {N}_{R B 1}^{C O R E S E T} > {N}_{RB 2}^{CORESET} .$$

The first pattern and the second pattern overlaps over the

$${N}_{s y m b 1}^{C O R E S E T}$$

symbols and the

$${N}_{R B 2}^{CORESET}$$

RBs. The method further includes determining a type of the UE, determining, based on the type of the UE, a pattern from the first pattern and the second pattern, and monitoring a PDCCH in the CORESET based on the determined pattern.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example CORESET bandwidth (BW) in relation to an associated bandwidth part (BWP) and carrier bandwidth according to embodiments of the present disclosure;

FIG. 6 illustrates an example resource element group (REG) of a CORESET according to embodiments of the present disclosure;

FIG. 7 illustrates example REG-to-CCE mappings for a CORESET according to embodiments of the present disclosure;

FIG. 8 illustrates an example synchronization signal block (SSB) utilized in a cell search procedure according to embodiments of the present disclosure;

FIG. 9 illustrates an example time-domain and frequency-domain allocation of a CORESET relative to a common resource block (CRB) and an SSB according to embodiments of the present disclosure;

FIGS. 10A-10C illustrate multiplexing patterns for multiplexing CORESET #0 with a corresponding SSB according to embodiments of the present disclosure;

FIGS. 11A-11C illustrate example CORESETs according to embodiments of the present disclosure;

FIG. 12A illustrates an example beam operation in a wireless communication system according to embodiments of the present disclosure;

FIG. 12B illustrates an example multi-beam operation in a wireless communication system according to embodiments of the present disclosure;

FIG. 13 illustrates an example of a transmitter structure for beamforming according to embodiments of the present disclosure;

FIG. 14 illustrates an example first configuration and second configuration of a CORESET according to embodiments of the present disclosure;

FIG. 15 illustrates an example of REG indexing for configurations of the CORESET according to embodiments of the present disclosure;

FIG. 16 illustrates another example of REG indexing for configurations of the CORESET according to embodiments of the present disclosure;

FIG. 17 illustrates an example of CCE indexing for configurations of the CORESET according to embodiments of the present disclosure;

FIG. 18 illustrates another example of CCE indexing for configurations of the CORESET according to embodiments of the present disclosure;

FIG. 19 illustrates an example of PDCCH candidate indexing for configurations of the CORESET according to embodiments of the present disclosure;

FIG. 20 illustrates another example of PDCCH candidate indexing for configurations of the CORESET according to embodiments of the present disclosure;

FIG. 21 illustrates examples of a DCI format indicating configuration of the CORESET of a slot according to embodiments of the present disclosure;

FIGS. 22A and 22B illustrate examples of multiple sets of resources for a CORESET according to embodiments of the present disclosure;

FIG. 23 illustrates an example of REG indexing for multiple sets of resources for a CORESET according to embodiments of the present disclosure;

FIG. 24 illustrates another example of REG indexing for multiple sets of resources for a CORESET according to embodiments of the present disclosure;

FIG. 25 illustrates an example of CCE indexing for multiple sets of resources for a CORESET according to embodiments of the present disclosure;

FIG. 26 illustrates another example of CCE indexing for multiple sets of resources for a CORESET according to embodiments of the present disclosure;

FIG. 27 illustrates an example of PDCCH candidate indexing for multiple sets of resources for a CORESET according to embodiments of the present disclosure;

FIG. 28 illustrates another example of PDCCH candidate indexing for multiple sets of resources for a CORESET according to embodiments of the present disclosure;

FIG. 29 illustrates examples of a DCI format indicating configuration of the CORESET of a slot according to embodiments of the present disclosure;

FIG. 30 illustrates another example of multiple sets of resources for a CORESET according to embodiments of the present disclosure;

FIG. 31 illustrates an example of REG indexing for multiple sets of resources for a CORESET according to embodiments of the present disclosure;

FIG. 32 illustrates another example of REG indexing for multiple sets of resources for a CORESET according to embodiments of the present disclosure; and

FIG. 33 illustrates an example method performed by a UE in a wireless communication system according to embodiments of the present disclosure.

### DETAILED DESCRIPTION

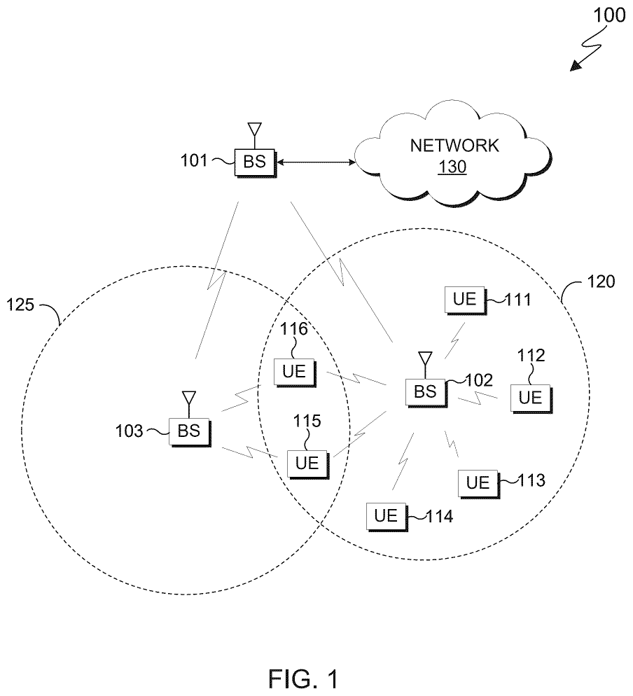

FIGS. 1-33 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.5.0, “NR; Physical Channels and Modulation” (herein, “REF 1”); 3GPP TS 38.212 v18.5.0, “NR; Multiplexing and Channel Coding” (herein, “REF 2”); 3GPP TS 38.213 v18.5.0, “NR; Physical Layer Procedures for Control” (herein, “REF 3”); 3GPP TS 38.214 v18.5.0, “NR; Physical Layer Procedures for Data” (herein, “REF 4”); 3GPP TS 38.321 v18.4.0, “NR; Medium Access Control (MAC) Protocol Specification” (herein, “REF 5”); and 3GPP TS 38.331 v18.4.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, BS, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing a unified CORESET design with multiple configurations and a unified common channel design for low bandwidth and high bandwidth UEs. In certain embodiments, one or more of the BSs 101-103 include circuitry, programing, or a combination thereof to support a unified CORESET design with multiple configurations and a unified common channel design for low bandwidth and high bandwidth UEs.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

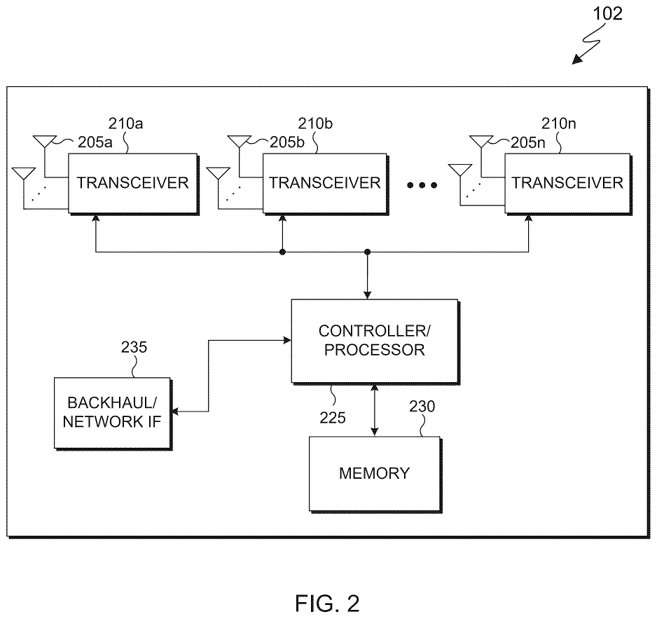

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling a unified CORESET design with multiple configurations and a unified common channel design for low bandwidth and high bandwidth UEs. Any of a wide variety of other functions could be supported in the BS 102 by the controller/processor 225.

The controller/processor 225 is also capable of executing programs and other processes resident in the memory 230, such as processes to support a unified CORESET design with multiple configurations and a unified common channel design for low bandwidth and high bandwidth UEs. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

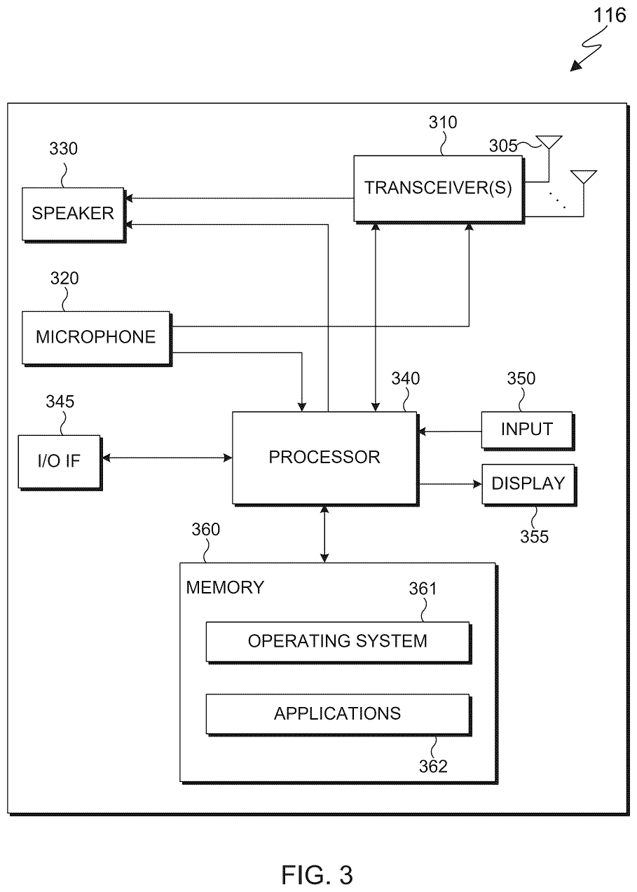

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing a unified CORESET design with multiple configurations and a unified common channel design for low bandwidth and high bandwidth UEs as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

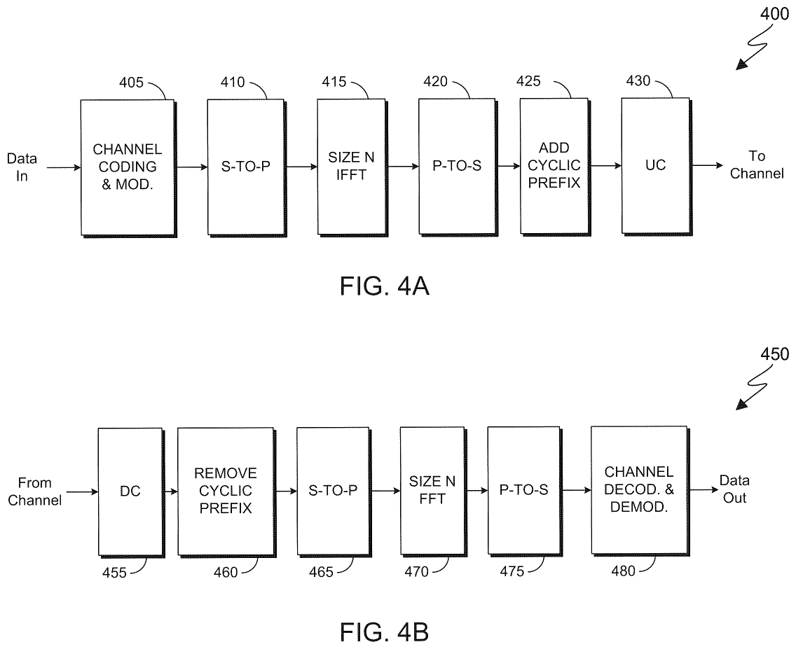

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting a unified CORESET design with multiple configurations and a unified common channel design for low bandwidth and high bandwidth UEs as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In the present disclosure and in general, a time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond, and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 38.212, are referred for brevity as a unicast DCI format. A DCI format scheduling PDSCH reception for multicast communication, such as a DCI format with CRC scrambled by G-RNTI/G-CS-RNTI as described in 38.212, are referred to as multicast DCI format. DCI formats providing various control information to at least a subset of UEs in a serving cell, such as DCI format 2_0 in 38.212, are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As aforementioned, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of TPC commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the DRX on-duration; (10) In IAB context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

The physical resources used for PDCCH are provided by a CORESET configuration. A CORESET configuration provides a time-frequency resource for each associated monitoring occasion, including:
Time and frequency domain resources
Transmission configuration indication state, for providing a resource reference signal for quasi-co-location (QCL) and a QCL type.
Scrambling information

A UE can be configured with one or more CORESETs. A CORESET configuration provides the following parameters:
Control resource set identifier (CORESET ID). A CORESET ID can identify a CORESET configuration.
Frequency domain resources. This is a bitmap of up to 45 bits. Each bit in the bitmap represents a group of 6 consecutive RBs. A “1” in the bitmap indicates that the corresponding group of 6 RBs is included in the CORESET, other a “0” indicates that the corresponding group of 6 RBs is not include in the bitmap.
Duration. The duration is the number of symbols of a CORESET. Duration∈{1,2,3} symbols.
CCE-REG mapping type. Mapping type can be interleaved or non-interleaved.
   Interleaved mapping type includes; (1) Interleaver size, (2) REG bundle size, and (3) shift index, when shift index is absent, UE applies PCI of serving cell.
precoderGranularity. This can be sameAsREG-bundle or allContiguousRBs.
rb-Offset. Indicates the RB level offset in units of RB from the first RB of the first 6RB group to the first RB of BWP.
pdcch-DMRS-ScramblingID
tci-StatesPDCCH-ToAddList
tci-StatesPDCCH-ToReleaseList
tci-PresentInDCI
controlResourceSetId
followUnifiedTCI-State
apply IndicatedTCI-State

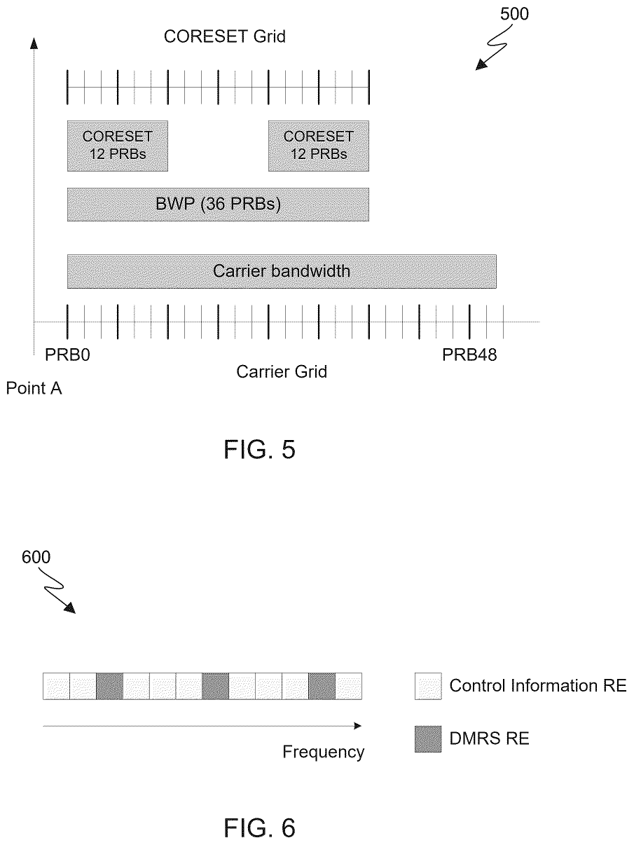

FIG. 5 illustrates an example CORSET BW 500 in relation to an associated bandwidth part (BWP) and carrier bandwidth according to embodiments of the present disclosure. For example, CORESET BW 500 can be implemented by BS 102 of FIG. 1. This example is for illustration only and other embodiments can be used without departing from the scope of the present disclosure.

As illustrated in FIG. 5, the CORESET BW 500 is configured in units of 6 resource blocks (RBs) on a 6 RB frequency grid within the associated BWP. Further, the CORESET BW 500 is configured within the bandwidth of the associated BWP. The groups of 6 RSs belonging to a CORESET is provided by a bitmap by higher layer parameter frequencyDomainResources. The number of RBs in a CORESET is denoted by

$${N}_{R B}^{CORESET} .$$

A CORESET can be configured with a duration of 1, 2 or 3 OFDM symbols, and is denoted by

$${N}_{s y m b}^{CORESET} .$$

A CORESET includes resource element groups (REGs), where a REG is 1 RB, i.e., 12 sub-carriers in one OFDM symbol. The number of REGs in a CORESET, is given by

$${N}_{R E G}^{CORESET} = {N}_{s y m b}^{CORESET} \cdot {N}_{R B}^{CORESET} .$$

FIG. 6 illustrates an example REG 600 of a CORESET according to embodiments of the present disclosure. For example, a CORESET including REG 600 can be implemented by BS 102 of FIG. 1. This example is for illustration only and other embodiments can be used without departing from the scope of the present disclosure.

As illustrated in FIG. 6, three resource elements of the REG are used for a demodulation reference signal (DMRS), and the remaining nine resource elements are used for carrying control information. A resource element is one sub-carrier in one symbol. A control channel element (CCE) includes 6 REGs.

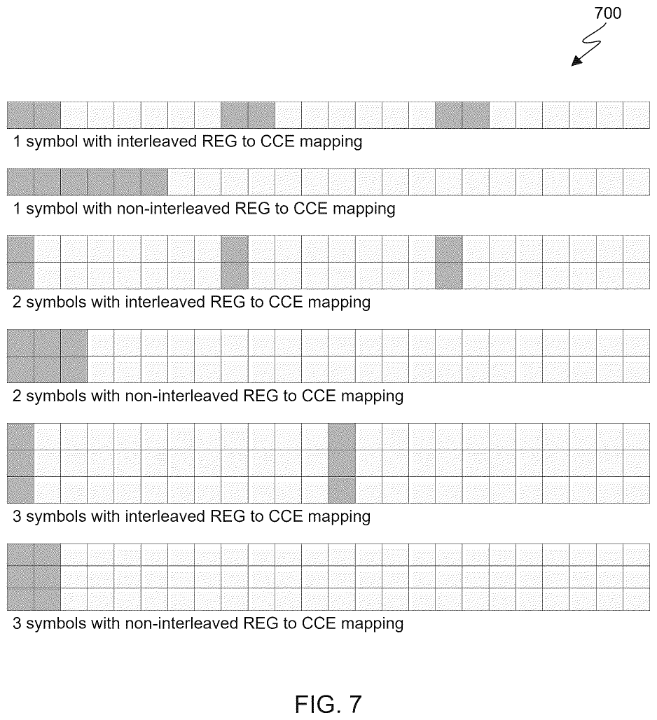

FIG. 7 illustrates example REG-to-CCE mappings 700 for a CORESET according to embodiments of the present disclosure. For example, REG-to-CCE mappings 700 can be utilized for a CORESET implemented by BS 102 of FIG. 1. These examples are for illustration only and other embodiments can be used without departing from the scope of the present disclosure.

A CCE can include one or more REG bundles, where a REG bundle is a set of adjacent REGs in time and/or frequency having a same precoding. As illustrated in FIG. 7 and Table 1 below, a REG bundle size, L, can be 2, 3 or 6 RBs. If

$${N}_{s y m b}^{CORESET} = 1 ,$$

### L∈{2,6}. If

$${N}_{s y m b}^{CORESET} = 2 , 3 , L ∈ \{ {N}_{s y m b}^{CORESET} , 6 \} .$$

As further illustrated in FIG. 7 and Table 1, there are two types of CCE-to-REG mapping:
Interleaved CCE-to-REG mapping, where there is one or more REG bundles, and the REGs of a CCE are distributed in frequency.
Non-interleaved CCE-to-REG mapping, where there is a single REG bundle, and the REGs of a CCE are contiguous in frequency.

TABLE 1
REG Bundle Size

| CORESET | Non-interleaved | Interleaved mapping |
|---|---|---|
| duration in | mapping bundle size | bundle size |
| symbols | (RBs × Symbols) | (RBs × Symbols) |
| 1 | 6 (6 × 1) | 2 (2 × 1), 6 (6 × 1) |
| 2 | 6 (6 × 1) | 2 (1 × 2), 6 (6 × 1) |
| 3 | 6 (6 × 1) | 3 (1 × 2), 6 (6 × 1) |

Interleaving achieves better frequency diversity, while a 6-PRB bundle with non-interleaving achieves better channel estimation. Both open-loop and closed-loop precoding are supported. Precoding is applied in a spec transparent manner where the same precoding weights are used across all resource elements of a REG bundle.

Each PDCCH candidate comprises of L of CCEs, where L is the aggregation level (AL). L∈{1,2,4,8,16}. AL 16 is introduced for coverage extension, achieving a gain of 2 to 3 dB over LTE AL 8 at BLER range 10⁻³ to 10⁻¹.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, UE initiated report indication (UEI) for a UE initiated beam report, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of CBs or CBGs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted herein as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

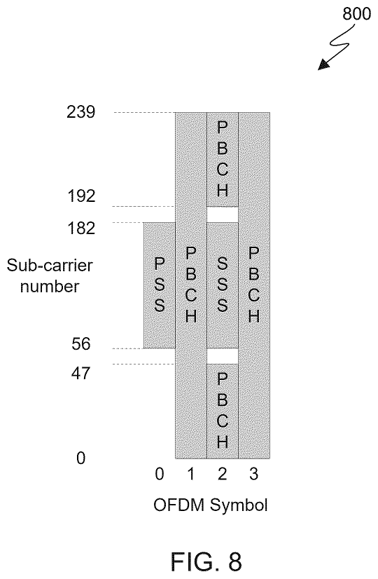

FIG. 8 illustrates an example SSB 800 utilized in a cell search procedure according to embodiments of the present disclosure. For example, SSB 800 can be transmitted by BS 102 or received by any one of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. As illustrated in FIG. 8, to perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 physical resource blocks (240 subcarriers).

SSBs are organized in groups or bursts of up to N SSBs, transmitted within half a frame, each SSB within the group has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The actual SSB indices transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

After detecting the PSS and SSS, the UE proceeds with receiving the PBCH. The PBCH provides the UE with essential information for accessing the system such as: (1) time domain information provided by SSB index and system frame number; (2) frequency domain information (offset of SSB in frequency domain relative to CRB); (3) information about how to receive other essential system information (configuration of CORESET zero and search space zero). This information can be provided by higher layers as part of the master information block (MIB) or can be information that the physical layer adds to the PBCH block as described later, or can be information implicitly included in the PBCH, e.g., carried by the PBCH DM-RS, as described later. For example, part of the SSB index (3 MSBs when Lₘₐₓ=64) is included in the PBCH block. Another part of the SSB index (e.g., 3 LSBs when Lₘₐₓ≥4 or 2 LSBs when Lₘₐₓ=4) are implicitly signaled based on scrambling code of encoded PBCH block or based on PBCH DM-RS sequence.

The master information block (MIB) is transmitted in the PBCH. The MIB contains critical information to allow the UE to access the system and receive the remaining minimum system information (RMSI) transmitted in SIB1. The MIB has a periodicity of 80 ms and can be repeated within the 80 ms period based on the periodicity of the SSB. The same MIB is transmitted across all SSBs within a same SSB burst set. The MIB block is defined as (TS 38.331):

```
MIB ::= SEQUENCE
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1 PDCCH-ConfigSIB1,
  cellBarred ENUMERATED {barred, notBarred},
  intraFreqReselection ENUMERATED {allowed, notAllowed},
  spare BIT STRING (SIZE (1))
}
Where:
PDCCH-ConfigSIB1 ::= SEQUENCE {
  controlResourceSetZero ControlResourceSetZero,
  searchSpaceZero SearchSpaceZero
}
```

For pdcch-ConfigSIB1: controlResourceSetZero is a 4-bit field. This field configures CORESET #0 for the UE to monitor a PDCCH scheduling SIB1. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1.

For pdcch-ConfigSIB1: searchSpaceZero is a 4-bit field. This field configures SearchSpace #0 for initial BWP for the UE to monitor a PDCCH scheduling SIB1. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1.

As aforementioned, SIB1 provides the UE the remaining minimum system information for the UE to access the system. SIB1 is carried by PDSCH scheduled by a PDCCH with a CRC scrambled by an SI-RNTI. The PDCCH is scheduled in Type1-PDCCH common search space (CSS) provided by Search Space #0 associated with CORESET #0.

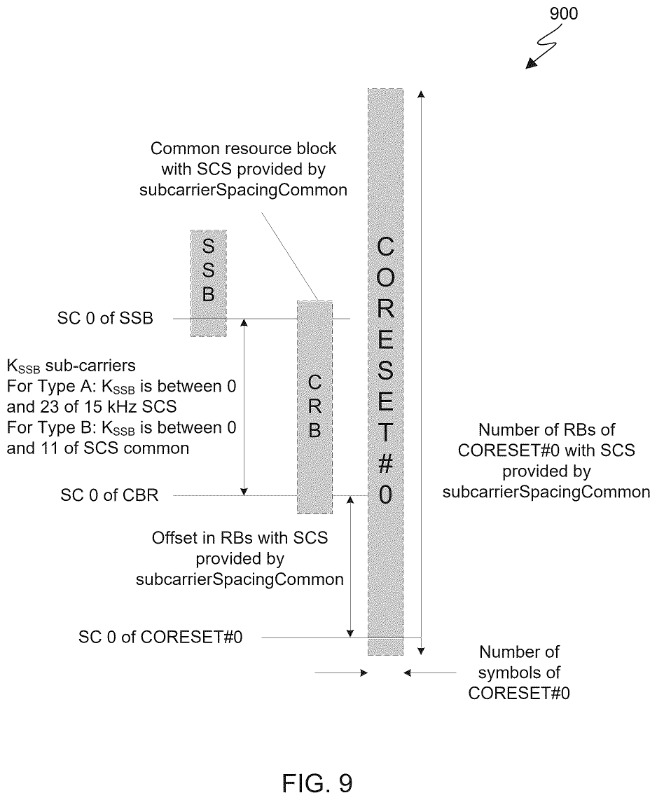

FIG. 9 illustrates an example time-domain and frequency-domain allocation 900 of a CORESET relative to a CRB and an SSB according to embodiments of the present disclosure. For example, allocation 900 can be determined by any of the UEs 111-116 of FIG. 1 based on certain parameters in the MIB provided by BS 102 of FIG. 1. This example is for illustration only and other embodiments can be used without departing from the scope of the present disclosure.

During a cell search, the UE can determine time-domain and frequency-domain allocation of a CORESET for Type0-PDCCH CSS set based on pdcch-ConfigSIB1->controlResourceSetZero in the MIB.
Based on the sub-carrier spacing of SSB (as determined by the UE), the sub-carrier spacing of SIB1 (as determined by subCarrierSpacingCommon in the MIB), and the minimum channel bandwidth, a table is selected from Table 13-0 to Table 13-10 of TS 38.213 for operation without shared spectrum channel access in FR1 and FR2-1, or as described in in Tables 13-1A and 13-4A of TS 38.213 for operation with shared spectrum channel access in FR1, or as described in Table 13-10A of TS 38.213 for FR2-2.
controlResourceSetZero is 4-bits (ranging from 0 to 15) and determines a row in the selected table.
Based on the determined row, the UE determines (1) the number of RBs of CORESET #0

$$( {N}_{R B}^{CORESET} ) ,$$

wherein

$${N}_{R B}^{CORESET} ∈ \{ 12 , 24 , 48 , 98 \} ;$$

(2) the number of symbols of CORESET #0

$$( {N}_{s y m b}^{CORESET} )$$

wherein

$${N}_{s y m b}^{CORESET} ∈ \{ 1 , 2 , 3 \} ,$$

the offset in RBs with respect to subCarrierSpacingCommon provided by the MIB, and the SS/PBCH block and CORESET multiplexing pattern.
The offset, in RBs with respect to subCarrierSpacingCommon, determines the starting RB of CORESET #0 relative to a common resource block with subCarrierSpacingCommon that overlaps sub-carrier 0 of the SS/PBCH block as illustrated in FIG. 9.

Table 13-0 has been introduced in Rel-18 for narrow-band UEs (with 3 MHz bandwidth). Table 13-0 allows for CORESETs with 12 RBs to fit within an allocation of a narrow-band UEs. At 15 kHz, a 12 RB CORESET has a bandwidth of 2.16 MHz, which is within the bandwidth of 3 MHz UE. However, a fewer number of RBs leads to fewer CCEs and fewer number of PDCCH candidates.

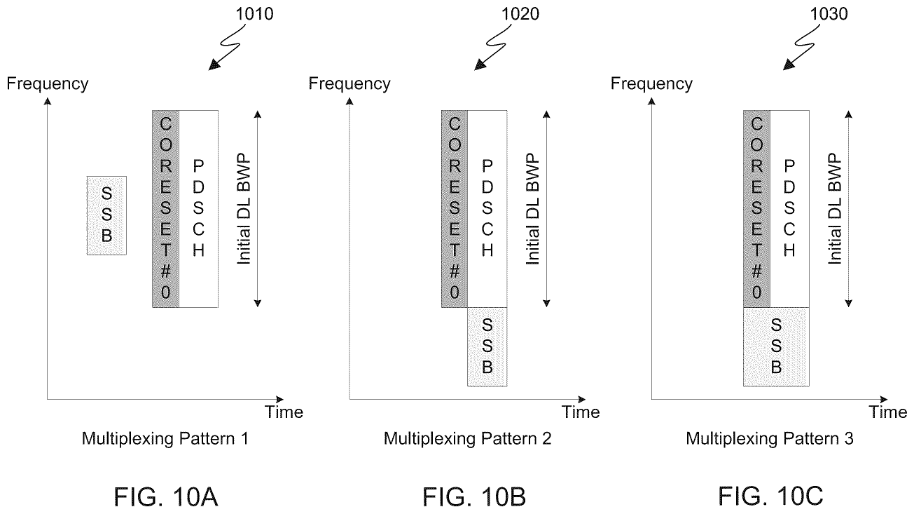

FIGS. 10A-10C illustrate multiplexing patterns 1010-1030 for multiplexing CORESET #0 with a corresponding SSB according to embodiments of the present disclosure. For example, multiplexing patterns 1010-1030 can be implemented by BS 102 of FIG. 1. This example is for illustration only and other embodiments can be used without departing from the scope of the present disclosure.

As illustrated in FIGS. 10A-10C, NR supports 3 multiplexing patterns for multiplexing CORESET #0 with the corresponding SSB.
Multiplexing pattern 1 can be used for FR1 or FR2. The SSB is time division multiplexed with the PDCCH scheduling SIB1, and SSB overlaps CORESET #0 in the frequency domain as illustrated in FIG. 10A.
Multiplexing pattern 2 and multiplexing pattern 3 are used for FR2, where beam-based operation facilitates communication between the gNB and the UE. Therefore, reducing beam sweeping overhead in the time domain is an important consideration. The larger system bandwidth in FR2 can be leveraged to frequency-division multiplex the SSB and the corresponding CORESET #0 as illustrated in FIG. 10B for multiplexing pattern 2 and in FIG. 10C for multiplexing pattern 3.

As aforementioned, CORESET #0 is configured by ControlResourceSetZero, and the following parameters determine the configuration of CORESET #0:

$${N}_{R B}^{CORESET} and {N}_{s y m b}^{CORESET}$$

are defined based on Tables 13-0 to 13-10 of TS 38.213.
Interleaved mapping
L=6
R=2

$${n}_{shift} = {N}_{ID}^{cell}$$

Normal cyclic prefix
Same precoding within REG bundle

As aforementioned, Table 13-0 of TS 38.213 was introduced in Rel-18 for small bandwidth UEs, and the allowed CORESET sizes are:
12 PRBs for 3 MHz (future railway mobile communication system (FRMCS))
   Has a special sync raster frequency
   CORESET size is 12 PRBs×2 or 3 symbols—24 or 36 REGs—4 or 6 CCEs.
   Maximum aggregation level is 4
   Interleaved pattern with R=2
15 PRBs for 3 MHz
   Multiple sync raster frequencies different from other NR sync raster points
   CORESET is 24 PRBs (with 9 PRBs punctured)×2 or 3 symbols—48 or 72 REGs—8 or 12 CCEs (3 CCEs or 5 CCEs punctured)
   With or without interleaving. For interleaving R=2.
20 PRBs for 5 MHz (FRMCS)
   Has a special sync raster frequency
   CORESET is 24 PRBs (with 4 PRBs punctured)×2 or 3 symbols—48 or 72 REGs—8 or 12 CCEs (2 CCEs punctured)
   Interleaved pattern with R=2

The present disclosure considers a CORESET configuration that can be used by normal UEs and low-bandwidth UEs, the structure of the CORESET, e.g., number of symbols and number of RBs depends on the type of UE. Signaling in the MIB and/or dynamic signaling can indicate the types of UE accessing the CORESET, and hence free-up resources not used.

In NR CORESET #0 can have a resource size in the frequency domain of 24 or 48 or 96 RBs. This corresponds to a bandwidth, which depends on the sub-carrier spacing of the CORESET, of 4.32, 8.64 or 17.28 MHz respectively at 15 kHz, and 8.64, 17.28 or 34.56 MHz respectively at 30 kHz, and 17.28, 34.56 or 69.12 MHz respectively at 60 kHz, and 34.28, 69.12 or 138.24 MHz respective at 120 kHz. Such bandwidth values can be too high for low-bandwidth UEs. In NR, this issue was address by one of the following: (1) Introducing a CORESET with 12 RBs, (2) puncturing RBs of the CORESET (or resource element groups (REGs)) that are outside the supported BWs of the UE.

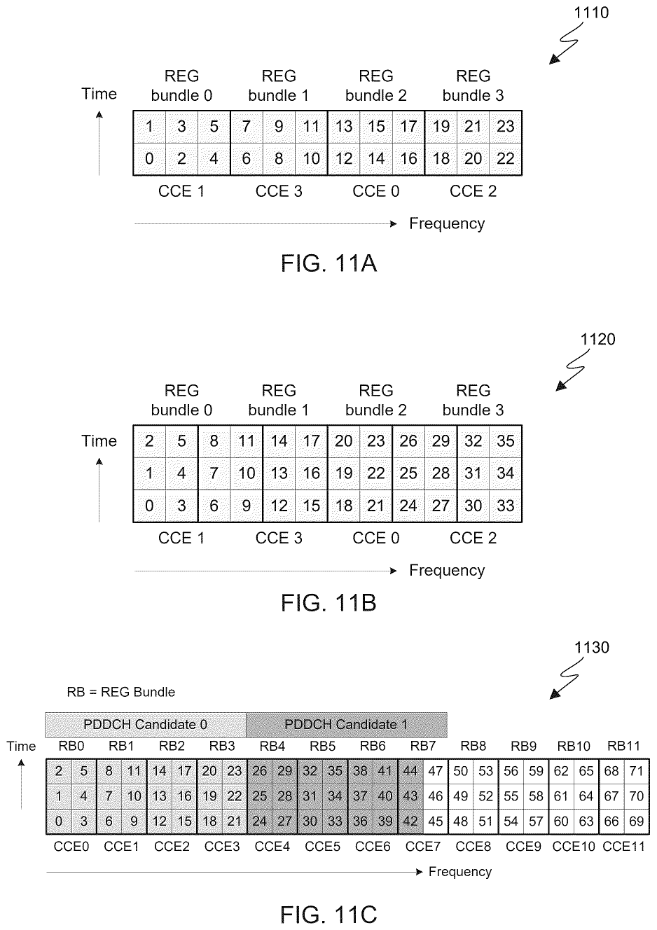

FIGS. 11A-11C illustrate example CORESETs 1110-1130 according to embodiments of the present disclosure. For example, CORESETs 1110-1130 can be implemented by BS 102 of FIG. 1. This example is for illustration only and other embodiments can be used without departing from the scope of the present disclosure.

Supporting a smaller number of RBs, with the same number of symbols for the CORESET, reduces the number of CCEs, and hence number of available PDCCHs candidates and/or the aggregation level. For example, FIG. 11A illustrates CORESET 1110 with 12 RBs and 2 symbols and CORESET 1120 with 12 RBs and 3 symbols. The number of CCEs is 4 and 6 respectively. With aggregation level (AL)=4, there is 1 PDCCH candidate, AL=8 is not possible as there is less than 8 CCEs available, and with AL=2, there is 2 or 3 PDCCH candidates respectively.

On the other hand, if REGs that are outside the bandwidth of the UE in a CORESET are punctured, this reduces the number of available PDCCH candidates and can lead to some PDCCH candidates with fewer REGs or CCEs. For example, FIG. 11C illustrates CORESET 1130 with 3 symbols and 24 RBs. The bandwidth of CORESET 1130 is limited to 15 RBs, therefore, the upper 9 RBs are punctured. CORESET 1130 of FIG. 11C is without interleaving. There are two PDCCH candidates with AL=4, the first PDCCH candidate has 4 CCEs, with each CCE having 6 REGs. The second PDCCH candidate has 4 CCEs, with 3 CCEs having 6 REGs, and one CCE have 3 REGs. Hence, the second PDCCH candidate has fewer resources and is expected to have less performance.

To address this issue, the present disclosure considers a CORESET with multiple configurations, for example, a first configuration with more RBs and less symbols used for standard or normal UEs with large BW, and a second configuration with less RBs and more symbols used for low-bandwidth UEs, the indexing of the REGs, CCEs and PDCCH candidate can be such that both types of UEs can co-exist in the CORESET. Alternatively, 2 CORESETs are configured that overlap, with a first CORESET with more RBs and less symbols used for standard or normal UEs with large BW, and second CORESET with less RBs and more symbols used for low-bandwidth UEs, the indexing of the REGs, CCEs and PDCCH candidate can be such that both types of UEs can co-exist in the CORESETs. While, the disclosure refers to the first description, the second description may be implemented/applied in a similar/corresponding manner. When one type of UEs is not used in a slot or monitoring occasion, the CORESET resources corresponding to that type of UE can be indicated as not being used or as being available and hence can be used for other channels such as DL transmissions or UL transmissions. Further, the present disclosure considers design and signalling aspects for a CORESET with multiple configurations.

Further in the present disclosure and in general, a beam can be determined by any of:
A TCI state, that establishes a quasi-colocation (QCL) relationship or spatial relation between a source reference signal (e.g. SSB and/or CSI-RS) and a target reference signal.
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

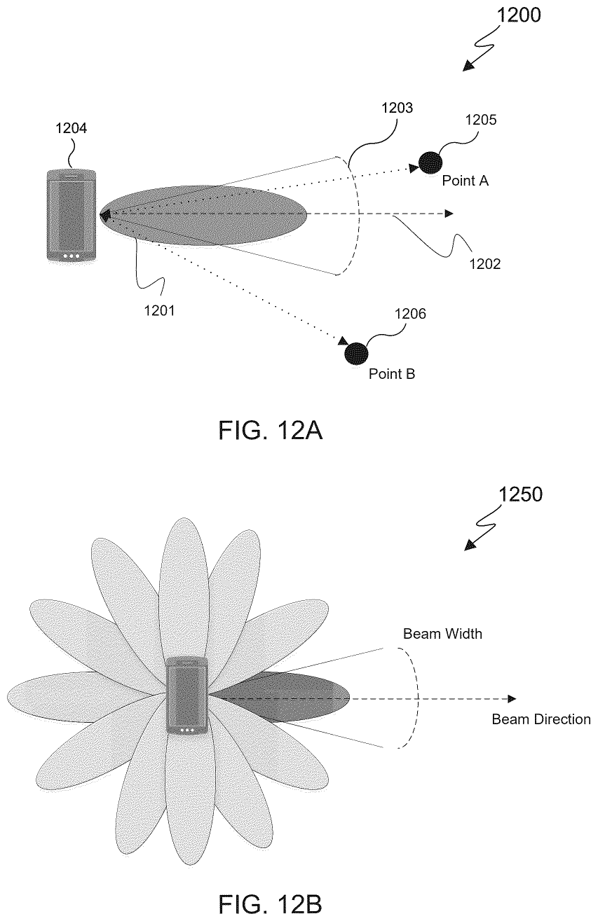

FIG. 12A illustrates an example beam operation 1200 in a wireless communication system according to embodiments of the present disclosure. For example, beam operation 1200 can be implemented by BS 102 and/or any of the UEs 111-116 of FIG. 1. This example is for illustration only and other embodiments can be used without departing from the scope of the present disclosure.

As illustrated in FIG. 12A, in a wireless system, a beam (1201), for a device (1204), can be characterized by a beam direction (1202) and a beam width (1203). For example, a device (1204) transmits radio frequency (RF) energy in a beam direction and within a beam width. A device (1204) receives RF energy in a beam direction and within a beam width. As illustrated in FIG. 12A, a device at point A (1205) can receive from and transmit to device (1204) as Point A is within a beam width and direction of a beam from device (1204). As illustrated in FIG. 12A, a device at point B (1206) cannot receive from and transmit to device (1204) as Point B is outside a beam width and direction of a beam from device (1204). While FIG. 12A, for illustrative purposes, shows a beam in 2-dimensions (2D), it should be apparent to those skilled in the art, that a beam can be in 3-dimensions (3D), where the beam direction and beam width are defined in space.

FIG. 12B illustrates an example multi-beam operation 1250 in a wireless communication system according to embodiments of the present disclosure. For example, multi-beam operation 1250 can be implemented by BS 102 and/or any of the UEs 111-116 of FIG. 1. This example is for illustration only and other embodiments can be used without departing from the scope of the present disclosure.

As illustrated in FIG. 12B, in a wireless system, a device can transmit and/or receive on multiple beams. This is known as “multi-beam operation.” While FIG. 12B, for illustrative purposes, shows beams in 2D, it should be apparent to those skilled in the art, that beams can be 3D, where the beams can be transmitted to or received from any direction in space.

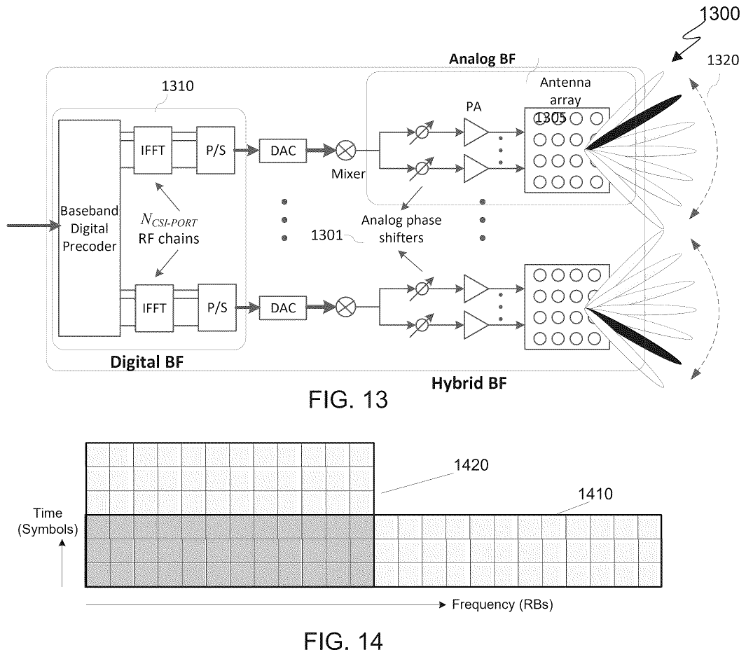

FIG. 13 illustrates an example of a transmitter structure 1300 for beamforming according to embodiments of the present disclosure. In certain embodiments, one or more of BS 102 or UE 116 includes the transmitter structure 1300. For example, one or more of antenna 205 and its associated systems or antenna 305 and its associated systems can be included in transmitter structure 1300. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 13. Then, one CSI-RS port can be mapped onto a large number of antenna elements that can be controlled by a bank of analog phase shifters 1301. One CSI-RS port can then correspond to one sub-array which produces a narrow analog beam through analog beamforming 1305. This analog beam can be configured to sweep across a wider range of angles 1320 by varying the phase shifter bank across symbols or slots/subframes. The number of sub-arrays (equal to the number of RF chains) is the same as the number of CSI-RS ports N_{CSI-PORT}. A digital beamforming unit 1310 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 1300 of FIG. 13 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 13 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [TS 38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

As introduced above, the present disclosure relates to a 5G/NR and/or 6G communication system. More particularly, this disclosure considers aspects related to design of a common CORESET #0 for standard UEs and low bandwidth UEs:
A CORESET has multiple configurations. A first configuration for standard UEs and a second configuration of low bandwidth UEs. Alternatively, multiple CORESETs can be configured, which each CORESET corresponding a configuration.
The standard UE configuration (or CORESET) uses fewer symbols with more resource blocks (RBs), while the low bandwidth UE configuration (or CORESET) uses more symbols with fewer resource blocks.
Indexing of resource element groups (REGs) can be such that REG indexing is aligned in the overlapping resources of the multiple configurations (or CORESETs).
Indexing of control channel elements (CCEs) can be such that CCEs indexing is aligned (or CCEs are aligned) in the overlapping resources of the multiple configurations (or CORESETs).
Indexing of PDCCH candidates can be such that PDCCH candidates are aligned (or indexing of PDCCH candidates is aligned) in the overlapping resources of the multiple configurations (or CORESETs).
Signaling in MIB to indicate supported configurations (or CORESETs) in a cell.
Signaling in a DCI Format to indicated supported configurations (or CORESETs) in a slot or a monitoring occasion (MO). For example, UE can use such signaling to determine resources to rate match around.

In the following, both FDD and TDD are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure considers several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH or sequence based signaling, e.g., where specific sequence can convey information) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element associated with index i. In one example, i can take N arbitrary values. In one example, i=0,1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure Msg5 refers to the message transmitted by the UE in response to Msg4. For example, Msg5 can be connection setup complete or resume complete.

Terminology such as TCI, TCI states, SpatialRelationInfo, target RS, reference RS, Msg1, Msg2, Msg3, Msg4, Msg5, MsgA, MsgB and other terms is used for illustrative purposes and is therefore not normative. Other terms that refer to same functions can also be used.

Terminology such as SS/PBCH block, PSS, SSS, PBCH, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part).

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the controlResourceSetZero provided by the MIB can indicate two sets of resources for a CORESET (or resources are provided for two respective CORESETs).
A first set of resources

$${N}_{s y m b 1}^{CORESET} \times {N}_{RB 1}^{CORESET}$$

starting at

$${N}_{start 1}^{CORESET} ,$$

for a first type or group of users (e.g., standard users with a large bandwidth), wherein

$${N}_{s y m b 1}^{CORESET}$$

is the duration of the first configuration of the CORESET in time units (e.g., symbols),

$${N}_{RB 1}^{CORESET}$$

is the frequency span of the first configuration of the CORESET in frequency units (e.g., resource blocks (RBs)), and

$${N}_{start 1}^{CORESET}$$

is the starting location of the first configuration of the CORESET in frequency units (e.g., sub-carriers and/or RBs).
A second set of resources

$${N}_{s y m b 2}^{C O R E S E T} \times {N}_{R B 2}^{C O R E S E T}$$

starting at

$${N}_{start 2}^{C O R E S E T} ,$$

for a second type of users (e.g., low bandwidth users), wherein

$${N}_{s y m b 2}^{C O R E S E T}$$

is the duration or the second configuration of the CORESET in time units (e.g., symbols),

$${N}_{R B 2}^{C O R E S E T}$$

is the frequency span of the first configuration of the CORESET in frequency units (e.g., resource blocks (RBs)), and

$${N}_{start 2}^{CORESET}$$

is the starting location of the second configuration of the CORESET in frequency units (e.g., sub-carriers and/or RBs).

FIG. 14 illustrates an example first configuration 1410 and second configuration 1420 of a CORESET according to embodiments of the present disclosure. For example, first and second configurations 1410 and 1420 can be implemented by BS 102 of FIG. 1. These examples are for illustration only and other embodiments can be used without departing from the scope of the present disclosure.

As illustrated in FIG. 14, in one example,

$${N}_{start}^{C O R E S E T} = {N}_{start 1}^{C O R E S E T} = {N}_{start 2}^{CORESET} ,$$

i.e., the first configuration 1410 of the CORESET and the second configuration 1420 of the CORESET have a same starting location. In one example, the first configuration 1410 of the CORESET and the second configuration 1920 of the CORESET overlap in the following resources,

$$min ( {N}_{s y m b 1}^{C O R E S E T} , {N}_{s y m b 2}^{C O R E S E T} ) \times min ( {N}_{R B 1}^{C O R E S E T} , {N}_{R B 2}^{C O R E S E T} ) .$$

Further, in FIG. 14, a CORSET has a first configuration 1410 of the CORESET of size 3 symbols×24 RBs, and a second configuration 1420 of the CORESET of size 6 symbols×12 RBs. In the example of FIG. 14, the first configuration 1410 of the CORESET and the second configuration 1420 of the CORESET overlap in 3 symbols×12 RBs. In one example, the number of resources of the first configuration and the second configuration are equal, e.g.,

$${N}_{s y m b 1}^{C O R E S E T} \times {N}_{R B 1}^{C O R E S E T} = {N}_{s y m b 2}^{C O R E S E T} \times {N}_{R B 2}^{C O R E S E T} .$$

In one example,

$${N}_{REG 1}^{C O R E S E T} = {N}_{s y m b 1}^{C O R E S E T} \times {N}_{R B 1}^{C O R E S E T} and$$

$${N}_{R E G 2}^{C O R E S E T} = {N}_{s y m b 2}^{C O R E S E T} \times {N}_{R B 2}^{C O R E S E T}$$

In one example,

$${N}_{REG}^{CORESET} = {N}_{REG 1}^{CORESET} = {N}_{REG 2}^{CORESET} .$$

In the following examples, Tables 3 to 6 provide sets of resource blocks and slot symbols of a CORESET of Type0-PDCCH search space (e.g., CORESET #0) for SS/PBCH block with sub-carrier spacing 15 kHz and CORESET #0 (or common channel) sub-carrier spacing 15 kHz.

In one example, the resources for the first configuration (or first CORESET) and the second configuration (or second CORESET) of the CORESET are defined in Table 3 below. In the example of Table 3, the number of RBs in the second configuration of the CORESET is half the number of RBs of the first configuration and the number of symbols of the second configuration is double the number of symbols of the first configuration. Further, in the example of Table 3, a same RB offset is used for the first and second configurations the CORESET. In a variant example, shown in Table 4 below, separate columns are used for the first configuration of the CORESET and the second configuration of the CORESET. In the example of Table 4, the RB offsets of the second configuration are small RB values (e.g., 0, 2 and 4).

TABLE 3
(modification of Table 13.1 if TS 38.213)

| | | 1^{st} Configuration | | 2^{nd} Configuration | | |
|---|---|---|---|---|---|---|
| | SS/PBCH block | Number of | Number of | Number of | Number of | |
| | and CORESET | RBs | Symbols | RBs | Symbols | |
| Index | multiplexing pattern | ${N}_{RB}^{CORESET}$ | ${N}_{symb}^{CORESET}$ | ${N}_{RB}^{CORESET}$ | ${N}_{symb}^{CORESET}$ | Offset (RBs) |
| 0 | 1 | 24 | 2 | 12 | 4 | 0 |
| 1 | 1 | 24 | 2 | 12 | 4 | 2 |
| 2 | 1 | 24 | 2 | 12 | 4 | 4 |
| 3 | 1 | 24 | 3 | 12 | 6 | 0 |
| 4 | 1 | 24 | 3 | 12 | 6 | 2 |
| 5 | 1 | 24 | 3 | 12 | 6 | 4 |
| 6 | 1 | 48 | 1 | 24 | 2 | 12 |
| 7 | 1 | 48 | 1 | 24 | 2 | 16 |
| 8 | 1 | 48 | 2 | 24 | 4 | 12 |
| 9 | 1 | 48 | 2 | 24 | 4 | 16 |
| 10 | 1 | 48 | 3 | 24 | 6 | 12 |
| 11 | 1 | 48 | 3 | 24 | 6 | 16 |
| 12 | 1 | 96 | 1 | 48 | 2 | 38 |
| 13 | 1 | 96 | 2 | 48 | 4 | 38 |
| 14 | 1 | 96 | 3 | 48 | 6 | 38 |

| | |
|---|---|
| 15 | Reserved |

TABLE 4
(modification of Table 13.1 of TS 38.213)

| | | 1^{st} Configuration | | | 2^{nd} Configuration | | |
|---|---|---|---|---|---|---|---|
| | SS/PBCH | | Number | | | Number | |
| | block and | Number | of | | Number | of | |
| | CORESET | of RBs | Symbols | | of RBs | Symbols | |
| Index | multiplexing pattern | ${N}_{RB}^{CORESET}$ | ${N}_{symb}^{CORESET}$ | Offset (RBs) | ${N}_{RB}^{CORESET}$ | ${N}_{symb}^{CORESET}$ | Offset (RBs) |
| 0 | 1 | 24 | 2 | 0 | 12 | 4 | 0 |
| 1 | 1 | 24 | 2 | 2 | 12 | 4 | 2 |
| 2 | 1 | 24 | 2 | 4 | 12 | 4 | 4 |
| 3 | 1 | 24 | 3 | 0 | 12 | 6 | 0 |
| 4 | 1 | 24 | 3 | 2 | 12 | 6 | 2 |
| 5 | 1 | 24 | 3 | 4 | 12 | 6 | 4 |
| 6 | 1 | 48 | 1 | 12 | 24 | 2 | 0 |
| 7 | 1 | 48 | 1 | 16 | 24 | 2 | 4 |
| 8 | 1 | 48 | 2 | 12 | 24 | 4 | 0 |
| 9 | 1 | 48 | 2 | 16 | 24 | 4 | 4 |
| 10 | 1 | 48 | 3 | 12 | 24 | 6 | 0 |
| 11 | 1 | 48 | 3 | 16 | 24 | 6 | 4 |
| 12 | 1 | 96 | 1 | 38 | 48 | 2 | 2 |
| 13 | 1 | 96 | 2 | 38 | 48 | 4 | 2 |
| 14 | 1 | 96 | 3 | 38 | 48 | 6 | 2 |

| | |
|---|---|
| 15 | Reserved |

In one example, the resources for the first configuration (or first CORESET) and the second configuration (or second CORESET) of the CORESET are defined in Table 5 below. In the example of Table 5, the number of RBs in the second configuration of the CORESET is a fixed value (e.g., 12 RBs) and the number of symbols of the second configuration determined such that the number of resources of the configuration and the second configuration are equal, and possibly not exceeding a maximum value (e.g., 12 symbols). Further, in the example of Table 5, a same RB offset is used for the first and second configurations the CORESET. In a variant example, shown in Table 6 below, separate columns are used for the first configuration of the CORESET and the second configuration of the CORESET. In the example of Table 6, the RB offsets of the second configuration are small RB values (e.g., 0, 2 and 4).

TABLE 5
(modification of Table 13.1 of TS 38.213)

| | | 1^{st} Configuration | | 2^{nd} Configuration | | |
|---|---|---|---|---|---|---|
| | SS/PBCH block | Number of | Number of | Number of | Number of | |
| | and CORESET | RBs | Symbols | RBs | Symbols | |
| Index | multiplexing pattern | ${N}_{RB}^{CORESET}$ | ${N}_{symb}^{CORESET}$ | ${N}_{RB}^{CORESET}$ | ${N}_{symb}^{CORESET}$ | Offset (RBs) |
| 0 | 1 | 24 | 2 | 12 | 4 | 0 |
| 1 | 1 | 24 | 2 | 12 | 4 | 2 |
| 2 | 1 | 24 | 2 | 12 | 4 | 4 |
| 3 | 1 | 24 | 3 | 12 | 6 | 0 |
| 4 | 1 | 24 | 3 | 12 | 6 | 2 |
| 5 | 1 | 24 | 3 | 12 | 6 | 4 |
| 6 | 1 | 48 | 1 | 12 | 4 | 12 |
| 7 | 1 | 48 | 1 | 12 | 4 | 16 |
| 8 | 1 | 48 | 2 | 12 | 8 | 12 |
| 9 | 1 | 48 | 2 | 12 | 8 | 16 |
| 10 | 1 | 48 | 3 | 12 | 12 | 12 |
| 11 | 1 | 48 | 3 | 12 | 12 | 16 |
| 12 | 1 | 96 | 1 | 12 | 8 | 38 |
| 13 | 1 | 96 | 2 | 12 | 16 [12 or 8] | 38 |
| 14 | 1 | 96 | 3 | 12 | 24 [12] | 38 |

| | |
|---|---|
| 15 | Reserved |

TABLE 6
(modification of Table 13.1 of TS 38.213)

| | | 1^{st} Configuration | | | 2^{nd} Configuration | | |
|---|---|---|---|---|---|---|---|
| | SS/PBCH | | Number | | | Number | |
| | block and | Number | of | | Number | of | |
| | CORESET | of RBs | Symbols | | of RBs | Symbols | |
| Index | multiplexing pattern | ${N}_{RB}^{CORESET}$ | ${N}_{symb}^{CORESET}$ | Offset (RBs) | ${N}_{RB}^{CORESET}$ | ${N}_{symb}^{CORESET}$ | Offset (RBs) |
| 0 | 1 | 24 | 2 | 0 | 12 | 4 | 0 |
| 1 | 1 | 24 | 2 | 2 | 12 | 4 | 2 |
| 2 | 1 | 24 | 2 | 4 | 12 | 4 | 4 |
| 3 | 1 | 24 | 3 | 0 | 12 | 6 | 0 |
| 4 | 1 | 24 | 3 | 2 | 12 | 6 | 2 |
| 5 | 1 | 24 | 3 | 4 | 12 | 6 | 4 |
| 6 | 1 | 48 | 1 | 12 | 12 | 4 | 0 |
| 7 | 1 | 48 | 1 | 16 | 12 | 4 | 4 |
| 8 | 1 | 48 | 2 | 12 | 12 | 8 | 0 |
| 9 | 1 | 48 | 2 | 16 | 12 | 8 | 4 |
| 10 | 1 | 48 | 3 | 12 | 12 | 12 | 0 |
| 11 | 1 | 48 | 3 | 16 | 12 | 2 | 4 |
| 12 | 1 | 96 | 1 | 38 | 12 | 8 | 2 |
| 13 | 1 | 96 | 2 | 38 | 12 | 16 [12 or 8] | 2 |
| 14 | 1 | 96 | 3 | 38 | 12 | 24 [12] | 2 |

| | |
|---|---|
| 15 | Reserved |

The examples of Tables 3, 4, 5, and 6 (e.g., based on adaptation of Table 13-1 of TS 38.213) are based on SS/PBCH block with sub-carrier spacing 15 kHz and CORESET #0 (or common channel) sub-carrier spacing 15 kHz. These can be similarly extended to Tables 13-2 to 13-10 of TS 38.213 for different SS/PBCH block sub-carrier spacings and CORESET #0 (or common channel) sub-carrier spacings.

In one example, a table is determined based on the sub-carrier spacing of the SS/PBCH block and/or the sub-carrier spacing of the CORESET #0 (or the BWP of CORESET #0 or sub-carrier spacing common).

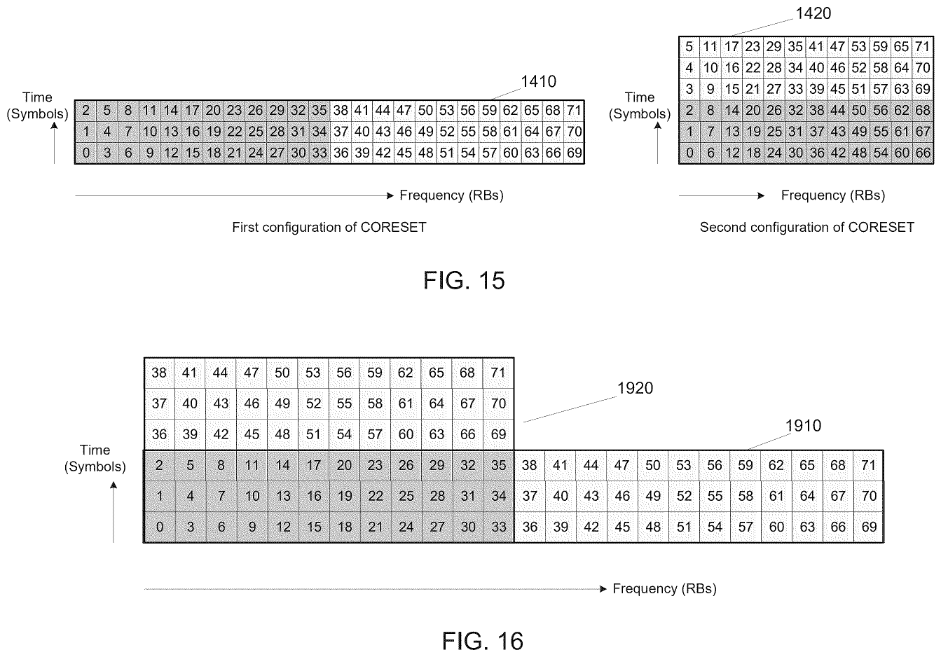

FIG. 15 illustrates an example of REG indexing for configurations 1410 and 1420 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

An REG is one frequency unit (e.g., RB) in one time unit (e.g., symbol). In one example, as illustrated in FIG. 15, REGs are numbered in increasing order of time first, and frequency second starting from 0 for the first OFDM symbol of the lowest-number resource block in each configuration of the CORESET. In FIG. 20, a REG of common region between the two configurations (or two CORESETs) 1410 and 1420 of the CORESET can have a different index.

FIG. 16 illustrates another example of REG indexing for configurations 1410 and 1420 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

In a variant example, as illustrated in FIG. 16, REGs are numbered in increasing order of time first, and frequency second starting from 0 for the first OFDM symbol of the lowest-number resource block of the common symbols of the configurations of the CORESET

$$( e . g . , min ( {N}_{s y m b 1}^{C O R E S E T} , {N}_{s y m b 2}^{C O R E S E T} ) ) ,$$

then in increasing order of the time first, and frequency second for the remaining symbols. In FIG. 16, a REG of common region between the two configurations 1410 and 1420 of the CORESET has a small index.

A control channel element (CCE) includes N REGs. In one example, N=6. In one example, there is a one CCE-to-REG mapping for each configuration of a CORESET. In one example, there is a one CCE-to-REG mapping for each configuration of a CORESET, and there is a common mapping in each common REGs of multiple configurations of the CORESET (or multiple overlapping CORESETs).

In one example, REGs are organized in bundles of size L REGs. In one example, L=N. In one example, L=N=6. In one example, REG bundle i includes REGs {iL, iL+1, . . . , iL+L−1}. In one example, L=6, and REG bundle i includes REGs {6i, 6i+1, 6i+2, 6i+3, 6i+4,6i+5}.

In one example, CCE j includes REG bundles

$$\{ f ( Nj / L ) , f ( \frac{N j}{L} + 1 ) , … , f ( \frac{N j}{L} + \frac{N}{L} - 1 ) \} .$$

In one example, N=L, and CCE j includes REG bundle f(j). In one example, CCE to REG bundle mapping can be non-interleaved or interleaved.

In one example, for non-interleaved CCE to REG bundle mapping f(x)=x.

In one example, for interleaved CCE to REG bundle mapping, f(x) is given by:

$$f ( x ) = ( r C + c + {n}_{s h i f t} ) mod ( {N}_{R E G}^{C O R E S E T} / L )$$

$$x = cR + r$$

$$r = 0 , 1 , … , R - 1$$

$$c = 0 , 1 , … , C - 1$$

$$C = {N}_{R E G}^{C O R E S E T} / ( LR )$$

In one example, R=2. In one example, R=3. In one example, R=6. In one example,

$${N}_{REG}^{CORESET}$$

can be replaced by

$${N}_{REG 1}^{CORESET}$$

for first configuration of CORESET. In one example,

$${N}_{REG}^{CORESET}$$

can be replaced by

$${N}_{REG 2}^{CORESET}$$

for a second configuration of CORESET. In one example

$${N}_{REG}^{CORESET} ,$$

L and R are such C is an integer. In one example n_{shift} is provided by a higher layer parameter, e.g., shift index. In one example,

$${n}_{shift} ∈ \{ 0 , 1 , … , {N}_{RB}^{MAX} - 1 \} .$$

In one example,

$${N}_{RB}^{MAX}$$

is the maximum number of RBs. In one example,

$${N}_{RB}^{MAX} = 275.$$

In one example, n_{shift} is the equal cell ID, e.g.,

$${N}_{ID}^{cell} .$$

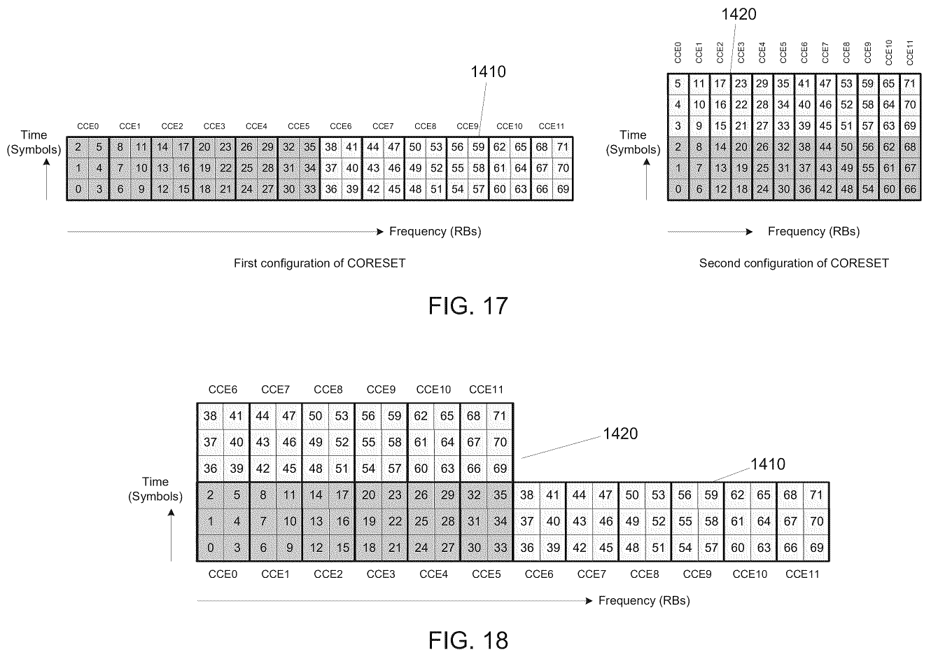

FIG. 17 illustrates an example of CCE indexing for configurations 1410 and 1420 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

In one example, the REG numbering or indexing is as illustrated in FIG. 15, L=N=6, and non-interleaved mapping is used for CCE to REG bundle mapping. The CCE indexing is as illustrated in FIG. 17. In the example of FIG. 17, a CCE of a first configuration 1410 of a CORESET (or first CORESET) can overlap with 2 CCEs of a second configuration 1420 of the CORESET (or second CORESET). For example, CCE 0 of the first configuration 1410 partially overlaps CCE 0 and CCE 1 of the second configuration 1420.

FIG. 18 illustrates another example of CCE indexing for configurations 1410 and 1420 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

In one example, the REG numbering or indexing is as illustrated in FIG. 16, L=N=6, and non-interleaved mapping is used for CCE to REG bundle mapping. The CCE indexing is as illustrated in FIG. 18. In the example of FIG. 18, the CCE numbering for the first and second configurations 1410 and 1420 of the CORESET (or first and second CORESETs) is the same in the overlapping region.

In one example, a physical downlink control channel (PDCCH) includes one or more CCEs. In one example, the number of CCEs in a PDCCH candidate is M. In one example, M is referred to as the aggregation level. In one example, M=1. In one example, M=2. In one example, M=4. In one example, M=8. In one example, M=16. In one example, M=32. In one example, M=64.

In one example, for aggregation level M, PDCCH candidate k includes CCEs {Mg(k),Mg(k)+1, . . . ,Mg(k)+M−1}. In one example, g(k) can depend on the CORESET index. In one example, g(k) can depend on higher layer configured parameters that can be cell common and/or UE specific. In one example, g(k)=k.

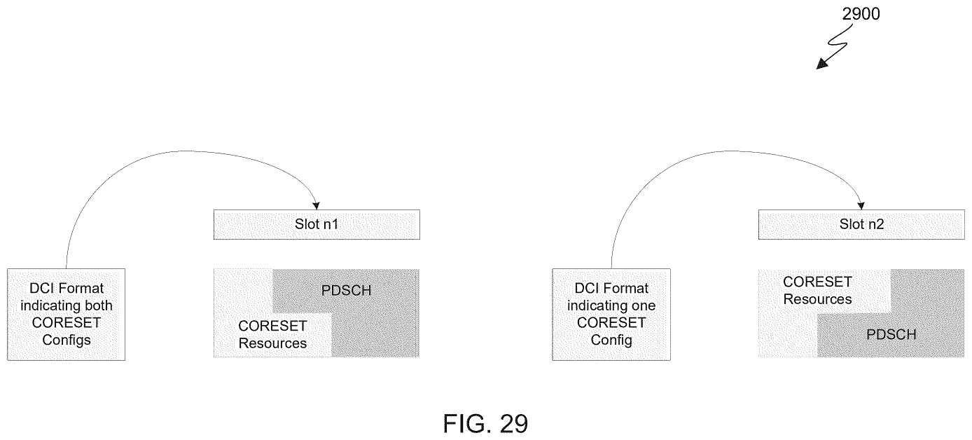

FIG. 29 illustrates an example of PDCCH candidate indexing for configurations 1910 and 1920 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

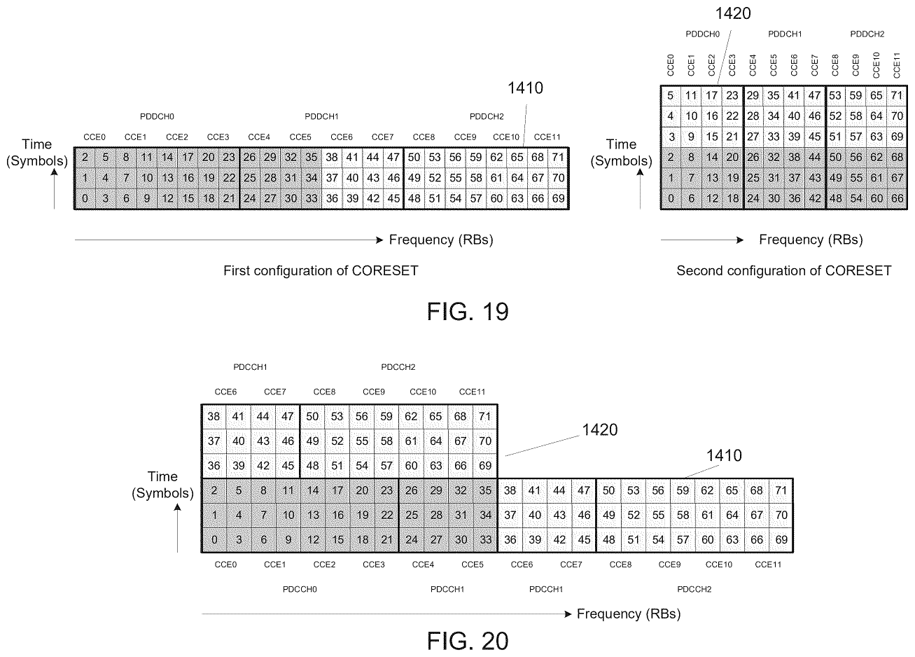

In one example, the REG numbering or indexing is as illustrated in FIG. 15, L=N=6, and non-interleaved mapping is used for CCE to REG bundle mapping and the CCE indexing is as illustrated in FIG. 17. The PDCCH candidate indexing is as illustrated in FIG. 19, with aggregation level M=4. In the example of FIG. 19, a PDDCH candidate of the first configuration 1410 of a CORESET can overlap with 2 PDCCH candidates of the second configuration 1420 of the CORESET. For example, PDDCH 0 of the first configuration (or first CORESET) 1410 partially overlaps PDCCH 0 and PDCCH 1 of the second configuration 1420 (or second CORESET).

FIG. 20 illustrates another example of PDCCH candidate indexing for configurations 1410 and 1420 of the CORESET according to embodiments of the present disclosure. Once again, as an example, configurations 1410 and 1420 can be implemented by BS 102 of FIG. 1. This example is for illustration only and other embodiments can be used without departing from the scope of the present disclosure.

In one example, the REG numbering or indexing is as illustrated in FIG. 16, L=N=6, and non-interleaved mapping is used for CCE to REG bundle mapping and the CCE indexing is as illustrated in FIG. 18. The PDCCH candidate indexing is as illustrated in FIG. 20, with aggregation level M=4. In the example of FIG. 20, the PDCCH numbering for the first and second configurations 1910 and 1920 of the CORESET (or first and second CORESETs) is the same in the overlapping region. In one example, some of the CCEs of a PDCCH candidate are common for the first and second configuration 1410 and 1420 of the CORESET and some of the CCEs candidate are separate for each configuration 1410 and 1420 of the CORESET. For example, PDCCH1 in FIG. 20 has CCE4 and CCE5 common for both configurations (or both CORESETs) 1410 and 1420 of the CORESET, while CCE6 and CCE7 are separate for each configuration (or each CORESET) 1910 and 1420 of the CORESET.

In the examples of FIGS. 17 to 20, non-interleaved REG-to-CCE mapping, and a REG bundle size (L) equal to N, is used for illustration. These examples can be extended to interleaved REG-to CCE mapping and/or bundle size (L) less than N.

In one example, based on the sub-carrier spacing of the SS/PBCH block and/or the sub-carrier spacing of the CORESET #0 (or the BWP of CORESET #0), the UE determines a table for the set of resource blocks and slot symbols of a CORESET for Type0-PDCCH search space (e.g., CORESET #0 or sub-carrier spacing common), e.g., similar to Tables 3 to 6. In one example, the sub-carrier spacing of the SS/PBCH block is determined by the UE measuring the sub-carrier spacing of the SS/PBCH block. In one example, the sub-carrier spacing of CORESET #0 is provided by the master information block (MIB), e.g., by parameter subCarrierSpacingCommon or similar parameter. In one example, the MIB provides an index for an entry in the table determined by the UE. In one example, the index is a 4-bit value (e.g., from 0 to 15). Based on the indexed provided in the MIB, the UE determines the set of resource blocks and slot symbols for first configuration of CORESET (e.g., CORESET #0) and/or for second configuration of CORESET (e.g., CORESET #0).

In one example, the MIB can include a field, and the field can indicate one of:
The field is 1-bit, and can indicate one of: (a) The resources configured for the CORESET in a cell follow one of the configurations of the CORESET only (e.g., first configuration, or the configuration corresponding to the UE type receiving the MIB). (b) The resources configured for the CORESET in a cell follow both configurations of the CORESET. In one example logical value 0 indicates (a) and logical value 1 indicates (b). In one example logical value 0 indicates (b) and logical value 1 indicates (a).
The field is 2-bits, and can indicate one of: (a) The resources configured for the CORESET in a cell follow the first configuration of the CORESET. (a) The resources configured for the CORESET in a cell follow the second configuration of the CORESET. (c) The resources configured for the CORESET in a cell follow both configurations of the CORESET.
In a variant example, first configuration of a CORESET is replaced by first CORESET, and second configuration of a CORESET is replaced by second CORESET.

In one example, the aforementioned field is included in the MIB of UEs of the first Type (e.g., using first configuration of CORESET). In one example, the aforementioned field is included in the MIB of UEs of the second Type (e.g., using second configuration of CORESET).

In one example, a UE can be indicated by a field in a DCI Format, one of the following:
The field is 1-bit, and can indicate one of: (a) The resources configured for the CORESET in a slot or monitoring occasion (MO) follow one of the configurations of the CORESET only (e.g., first configuration or the configuration corresponding to the UE type receiving the DCI Format). (b) The resources configured for the CORESET in a slot/MO follow both configurations of the CORESET. In one example logical value 0 indicates (a) and logical value 1 indicates (b). In one example logical value 0 indicates (b) and logical value 1 indicates (a). In various embodiments, the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot/MO of the DCI format until a next slot/MO after a slot/MO with a second DCI format that includes the field. (8) All slots/MOs (e.g. of the CORESET) from next DL slot/MO after the slot/MO of the DCI format until a next DL slot/MO after a slot with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.
The field is 2-bits, and can indicate one of: (a) The resources configured for the CORESET in a slot/MO follow the first configuration of the CORESET. (a) The resources configured for the CORESET in a slot/MO follow the second configuration of the CORESET. (c) The resources configured for the CORESET in a slot/MO follow both configurations of the CORESET. In a variant example, a code point of the 2-bit field can additionally indicate that the resources configured for both configurations of the CORESET in a slot/MO are not used for PDCCH (e.g., available for other channels and signals such as PDSCH or PUSCH). In various embodiments, the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot/MO of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot of the DCI format until a next slot/MO after a slot/MO with a second DCI format that includes the field. (8) All slots/MOs (e.g. of the CORESET) from next DL slot/MO after the slot/MO of the DCI format until a next DL slot/MO after a slot/MO with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.

In one example, the aforementioned field is included in a DCI Format of UEs of the first Type (e.g., using first configuration of CORESET or first CORESET). In one example, the aforementioned field is included in a DCI Format of UEs of the second Type (e.g., using second configuration of CORESET or second CORESET).

Based on the resources indicated by the DCI Format (e.g., resources of one configuration or both configurations of a CORESET), the UE can rate match a PDSCH transmission or a PUSCH transmission around the resources used for the indicated configuration(s) of the CORESET.

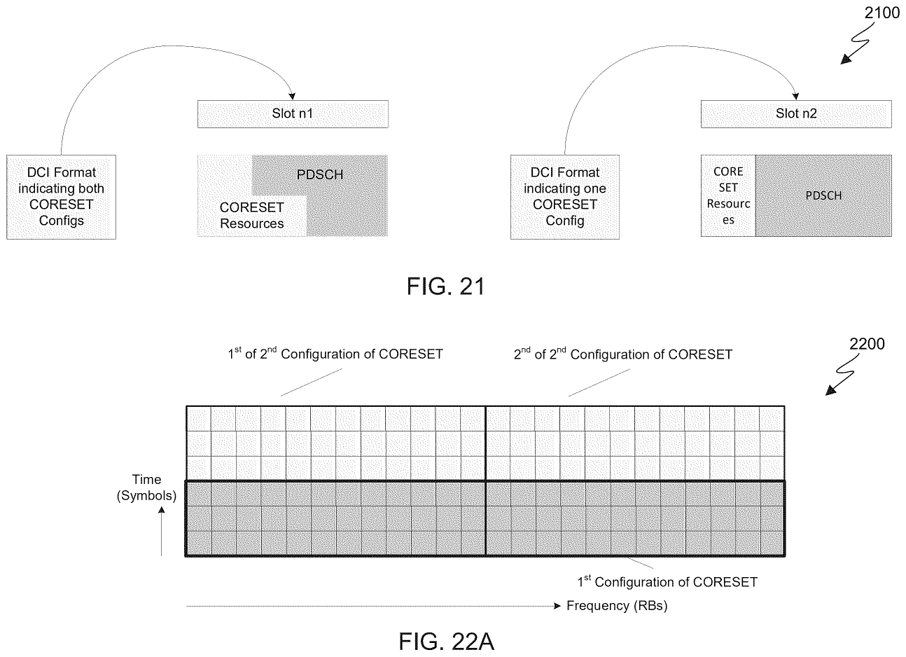

FIG. 21 illustrates examples of a DCI format 2100 indicating configuration of the CORESET of a slot according to embodiments of the present disclosure. For example, DCI format 2100 can be utilized by BS 102 of FIG. 1. This example is for illustration only and other embodiments can be used without departing from the scope of the present disclosure.

In one example, the DCI Format can be DL related DCI Format, e.g., similar to DCI Format 1_1 or DCI Format 1_2 in NR. In one example, a DCI Format can be a UE common DCI Format (e.g., received by UEs of a certain type) using a group common RNTI. As illustrated in FIG. 21, DCI format 2100 is transmitted indicating that in slot n1, resources are used for both configurations of the CORESET. A PDSCH is transmitted in slot n1 and is rate matched around the resources of both configurations of the CORESET. Further, DCI format 2600 is transmitted indicating that in slot n2, resources are used for first configuration of the CORESET. A PDSCH is transmitted in slot n2 and is transmitted in resources not used for the first configurations of the CORESET. In a variant example, a DCI Format can be replaced by a sequence-based signal, wherein a sequence indicates a CORESET configuration (or a CORESET to use).

In one example, rate-matching patterns are defined to include one or more of:
A rate matching pattern for resources of first configuration of the CORESET (or first CORESET).
A rate matching pattern for resources of second configuration of the CORESET (or second CORESET).
A rate matching pattern for resources of both configurations of the CORESET (or both CORESETs).
A rate matching pattern for resources of configuration of the CORESET (or CORESET) corresponding to the UE type.
In a variant example, the rate matching can indicate that the resources of both configurations of the CORESET (or both CORESETs) are not used for PDCCH and are available for other channels or signals (e.g., PDSCH or PUSCH).

In various embodiments, each rate matching pattern can correspond to an ID, other IDs can correspond to other rate matching patterns. In one example, the rate matching pattern is for the resources around which PDSCH is rate matched. In one example, the rate matching pattern ID is indicated in a DCI format as previously mentioned. In one example, the rate matching pattern can apply to a slot or a monitoring occasion (MO), wherein the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot/MO of the DCI format until a next slot after a slot/MO with a second DCI format that includes the field. (8) All slots/MOs (e.g. of the CORESET) from next DL slot/MO after the slot/MO of the DCI format until a next DL slot/MO after a slot/MO with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.

In one example, the controlResourceSetZero provided by the MIB can indicate multiple sets of resources for a CORESET (or multiple CORESETs), a first set of resources for a first configuration of a CORESET and K second sets of resources for K of a second configuration of the CORESET. In the following, without loss of generality, it is assumed that

$${N}_{RB 2}^{CORESET} \leq {N}_{RB 1}^{CORESET} .$$

A first set of resources

$${N}_{symb 1}^{CORESET} \times {N}_{RB 1}^{CORESET}$$

starting at

$${N}_{start 1}^{CORESET} ,$$

for a first type or group of users (e.g., standard users with a large bandwidth), wherein

$${N}_{symb 1}^{CORESET}$$

is the duration of the first configuration of the CORESET in time units (e.g., symbols),

$${N}_{RB 1}^{CORESET}$$

is the frequency span of the first configuration of the CORESET in frequency units (e.g., resource blocks (RBs)), and

$${N}_{start 1}^{CORESET}$$

is the starting location of the first configuration of the CORESET in frequency units (e.g., sub-carriers and/or RBs).
A second set(s) of resources

$${N}_{symb 2}^{CORESET} \times {N}_{RB 2}^{CORESET}$$

starting at

$${N}_{start 2 - k}^{CORESET} ,$$

where k=0, 1, . . . . K−1, for a second type of users (e.g., low bandwidth users), wherein

$${N}_{symb 2}^{CORESET}$$

is the duration of the second configuration of the CORESET in time units (e.g., symbols),

$${N}_{RB 2}^{CORESET}$$

is the frequency span or the first configuration of the CORESET in frequency units (e.g., resource blocks (RBs)). There are K second set(s) of resources, wherein the (k+1)th second set of resources starts at

$${N}_{start 2 - k}^{CORESET} , and {N}_{start 2 - k}^{CORESET}$$

is in frequency units (e.g., sub-carriers and/or RBs).
In a variant example, first configuration of a CORESET is replaced by first CORESET, and kth second configuration of a CORESET is replaced by kth second CORESET.

In one example, having K second set(s) for resources for the second type of users allows the distribution of the second type of users among the K second set(s) of resources. In one example, a subset (a subset can also include the full set or an empty set) of the K second set(s) of resources is used, wherein the subset can be indicated or signaled to the users of the cell (e.g., to the first type of users). In one example, this signaling can allow the first type of users to determine the resources to use or the resources to avoid (e.g., rate match around) when transmitting to/from the network.

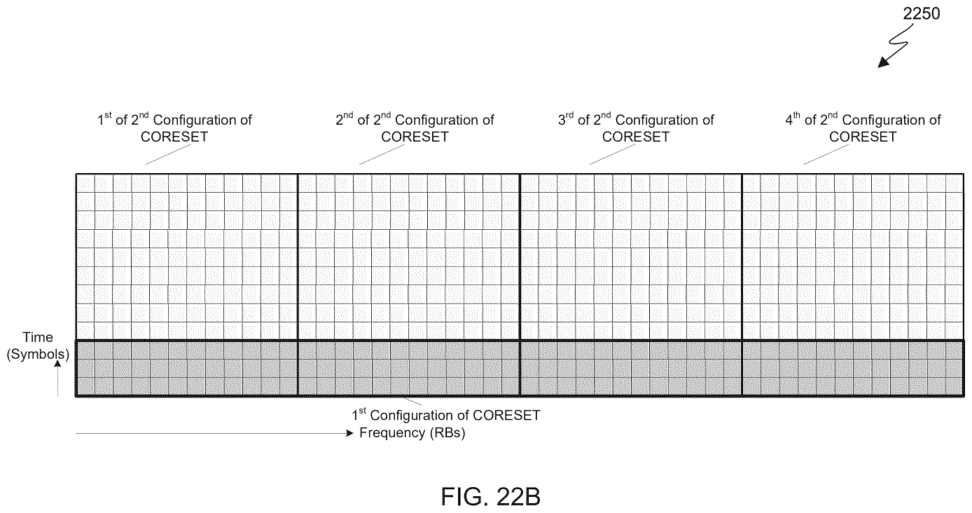

FIGS. 22A and 22B illustrate examples of multiple sets of resources 2200 and 2250, respectively, for a CORESET according to embodiments of the present disclosure. More particularly, FIGS. 22A-22B illustrate a first set of resources for a first configuration of a CORESET and K second sets of resources for K of a second configuration of the CORESET. For example, multiple sets of resources 2200 and 2250 can be implemented by BS 102 of FIG. 1. These examples are for illustration only and other embodiments can be used without departing from the scope of the present disclosure.

In one example,

$${N}_{start 2 - k}^{CORESET}$$

is selected such the K second set(s) of resources do not overlap. In one example.

$${N}_{start 2 - k}^{CORESET}$$

is selected such the K second set(s) of resources are adjacent to each other. In one example,

$${N}_{start 2 - k}^{CORESET} = {N}_{start 2 - 0}^{CORESET} + k * {N}_{RB 2}^{CORESET} .$$

As illustrated in FIG. 22A, in one example,

$${N}_{start}^{CORESET} = {N}_{start 2 - 0}^{CORESET} = {N}_{start 1}^{CORESET} ,$$

i.e., the first configuration of the CORESET and the first, second configuration of the CORESET have a same starting location. In one example, the first configuration of the CORESET and each of the K second configuration(s) of the CORESET overlap in the following resources,

$$min ( {N}_{symb 1}^{CORESET} , {N}_{symb 2}^{CORESET} ) \times min ( {N}_{RB 1}^{CORESET} , {N}_{RB 2}^{CORESET} ) .$$

In FIG. 22A, K=2. Further, in FIG. 22A, a CORESET has a first configuration of the CORESET of size 3 symbols×24 RBs, and a first of second configuration of the CORESET of size 6 symbols×12 RBs, starting at the same RB as the first configuration of the CORESET, and a second of second configuration of the CORESET of size 6 symbols×12 RBs, starting at an offset of 12 RBs from the starting RB of the first configuration of the CORESET. In the example of FIG. 22A, the first configuration of the CORESET and each of the second configuration of the CORESET overlap in 3 symbols×12 RBs.

In FIG. 22B, K=4. In FIG. 22B, a CORESET has a first configuration of the CORESET of size 3 symbols×48 RBs, and a first of second configuration of the CORESET of size 12 symbols×12 RBs, starting at the same RB as the first configuration of the CORESET, and a second of second configuration of the CORESET of size 12 symbols×12 RBs, starting at an offset of 12 RBs from the starting RB of the first configuration of the CORESET, and a third of second configuration of the CORESET of size 12 symbols×12 RBs, starting at an offset of 24 RBs from the starting RB of the first configuration of the CORESET, and a fourth of second configuration of the CORESET of size 12 symbols×12 RBs, starting at an offset of 12 RBs from the starting RB of the first configuration of the CORESET. In the example of FIG. 22B, the first configuration of the CORESET and each of the second configurations of the CORESET overlap in 3 symbols×12 RBs.

In one example, the number of resources of the first configuration and the second configuration are equal, e.g.,

$${N}_{symb 1}^{CORESET} \times {N}_{RB 1}^{CORESET} = {N}_{symb 2}^{CORESET} \times {N}_{RB 2}^{CORESET} .$$

In one example,

$${N}_{REG 1}^{CORESET} = {N}_{symb 1}^{CORESET} \times {N}_{RB 1}^{CORESET} and {N}_{REG 2}^{CORESET} = {N}_{symb 2}^{CORESET} \times {N}_{RB 2.}^{CORESET} .$$

In one example,

$${N}_{REG}^{CORESET} = {N}_{REG 1}^{CORESET} = {N}_{REG 2}^{CORESET} .$$

Tables similar to Tables 3 to 6 can provide sets of resource blocks and slot symbols of a CORESET of Type0-PDCCH search space (e.g., CORESET #0) for SS/PBCH block with sub-carrier spacing 15 kHz and CORESET #0 (or common channel) sub-carrier spacing 15 kHz.

In one example, for the second configuration of the CORESET, the RB offset is provided for the second configuration of the CORESET with index k=0. The RB offset for other second configurations of the CORESET can be calculated based on

$${N}_{start 2 - 0}^{CORESET}$$

and k e.g., as aforementioned.

In one example, for the second configuration of the CORESET, an entry in the table can correspond to one of the second configurations of the CORESET.

The examples of Tables 3, 4, 5, and 6 (e.g., based on adaptation of Table 13-1 of TS 38.213) are based on SS/PBCH block with sub-carrier spacing 15 kHz and CORESET #0 (or common channel) sub-carrier spacing 15 kHz. These can be similarly extended to Tables 13-2 to 13-10 of TS 38.213 for different SS/PBCH block sub-carrier spacings and CORESET #0 (or common channel) sub-carrier spacings.

In one example, a table is determined based on the sub-carrier spacing of the SS/PBCH block and/or the sub-carrier spacing of the CORESET #0 (or the BWP of CORESET #0 or sub-carrier spacing common).

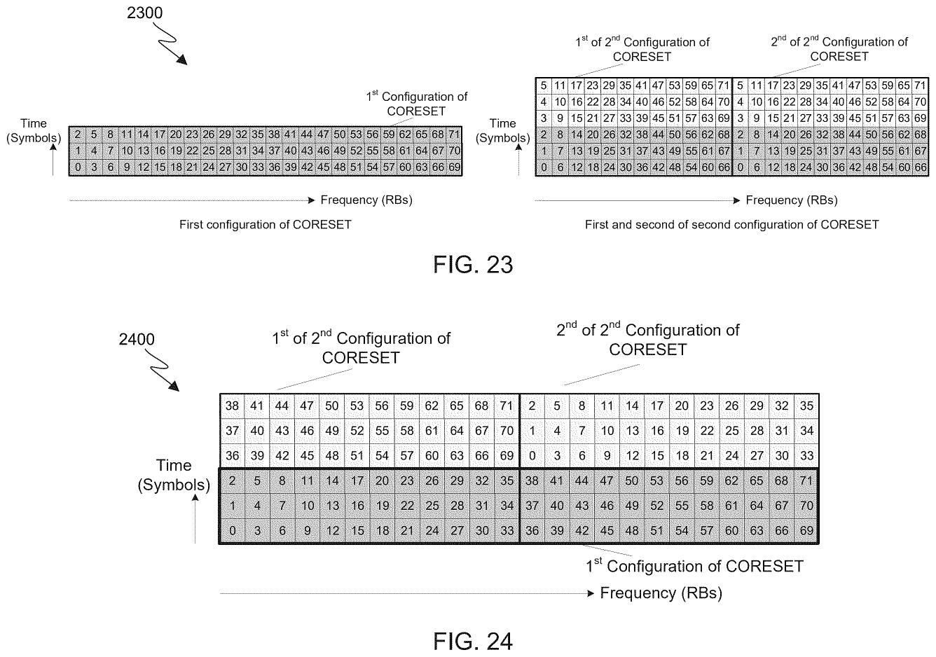

FIG. 23 illustrates an example of REG indexing for multiple sets of resources 2300 for a CORESET according to embodiments of the present disclosure. Once again, as an example, multiple sets of resources 2300 can be implemented by BS 102 of FIG. 1. This example is for illustration only and other embodiments can be used without departing from the scope of the present disclosure.

As aforementioned, a resource-element group (REG) is one frequency unit (e.g., RB) in one time unit (e.g., symbol). In one example, as illustrated in FIG. 23, REGs are number in increasing order of time first, and frequency second starting from 0 for the first OFDM symbol of the lowest-number resource block in each configuration of the CORESET. In FIG. 28, K=2. Further, in FIG. 23, a REG of common region between the configurations of the CORESET can have a different index.

FIG. 24 illustrates another example of REG indexing for multiple sets of resources 2400 for a CORESET according to embodiments of the present disclosure. Once again, as an example, multiple sets of resources 2400 can be implemented by BS 102 of FIG. 1. This example is for illustration only and other embodiments can be used without departing from the scope of the present disclosure.

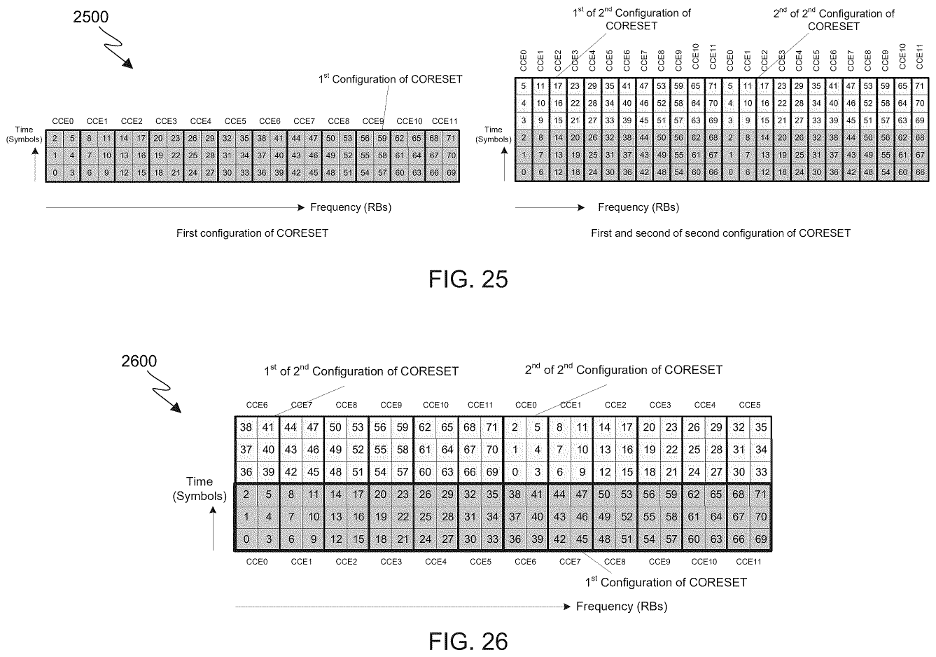

In a variant example, as illustrated in FIG. 25, REGs are number in increasing order of time first, and frequency second starting from 0 for the first OFDM symbol of the lowest-number resource block of the common symbols of the configurations of the CORESET

$$( e . g . , min ( {N}_{symb 1}^{CORESET} , {N}_{symb 2}^{CORESET} ) ) ,$$

then in increasing order of time first, and frequency second for the remain symbols. In FIG. 25, K=2. Further, in FIG. 25, a REG of common region between the two configurations of the CORESET has a small index. As illustrated, the numbering or indexing of REGs is first across REGs of configuration of CORESET with largest number of RBs, e.g., first configuration of CORESET, in increasing time then increasing frequency, then the remaining REGs of each of the remaining configuration(s) of CORESET (e.g., second configuration(s) of CORESET) for the remaining REG indices of those configuration(s), the indexing is in increasing time then increasing frequency.

As aforementioned, control channel element (CCE) includes N REGs. In one example, as aforementioned, REGs are organized in bundles of size L REGs. In one example, L=N. In one example, L=N=6. In one example, as aforementioned, the CCE to REG bundle mapping is non-interleaved. In one example, as aforementioned, the CCE to REG bundle mapping is interleaved.

FIG. 25 illustrates an example of CCE indexing for multiple sets of resources 2500 for a CORESET according to embodiments of the present disclosure. Once again, as an example, multiple sets of resources 2500 can be implemented by BS 102 of FIG. 1. This example is for illustration only and other embodiments can be used without departing from the scope of the present disclosure.

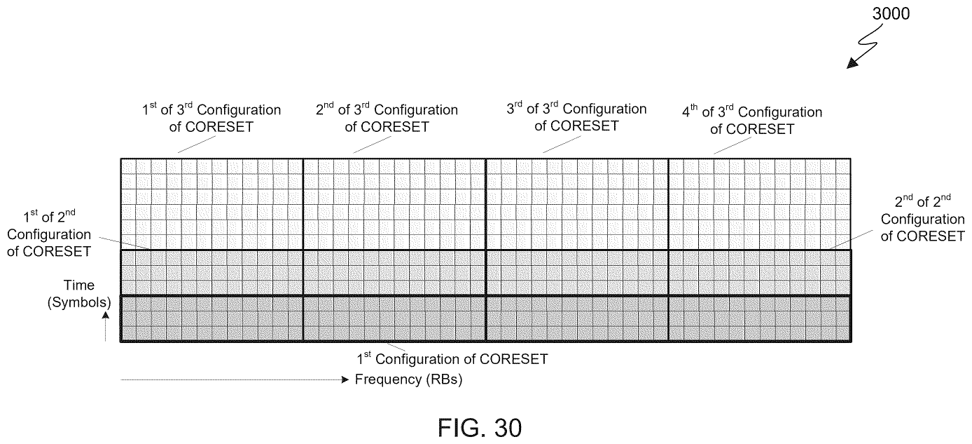

In one example, the REG numbering or indexing is as illustrated in FIG. 23, L=N=6, and non-interleaved mapping is used for CCE to REG bundle mapping. The CCE indexing is as illustrated in FIG. 30. In the example of FIG. 25, a CCE of a first configuration of a CORESET can overlap with 2 CCEs of a second configuration of the CORESET. For example, CCE 0 of the first configuration of the CORESET partially overlaps CCE 0 and CCE 1 of the first of the second configuration of the CORESET. For example, CCE 6 of the first configuration of the CORESET partially overlaps CCE 0 and CCE 1 of the second of the second configuration of the CORESET.

FIG. 26 illustrates another example of CCE indexing for multiple sets of resources 2600 for a CORESET according to embodiments of the present disclosure. Once again, as an example, multiple sets of resources 2600 can be implemented by BS 102 of FIG. 1. This example is for illustration only and other embodiments can be used without departing from the scope of the present disclosure.

In one example, the REG numbering or indexing is as illustrated in FIG. 24, L=N=6, and non-interleaved mapping is used for CCE to REG bundle mapping. The CCE indexing is as illustrated in FIG. 26. In the example of FIG. 26, the CCE numbering for the first configuration of the CORESET and each of the second configuration(s) of the CORESET is the same in the overlapping region.

In one example, as aforementioned, a physical downlink control channel (PDCCH) includes one or more CCEs. In one example, the number of CCEs in a PDCCH candidate is M. In one example, M is referred to as the aggregation level, wherein the values of M can be as aforementioned. In one example, the CCEs of a PDCCH candidate can be as aforementioned.

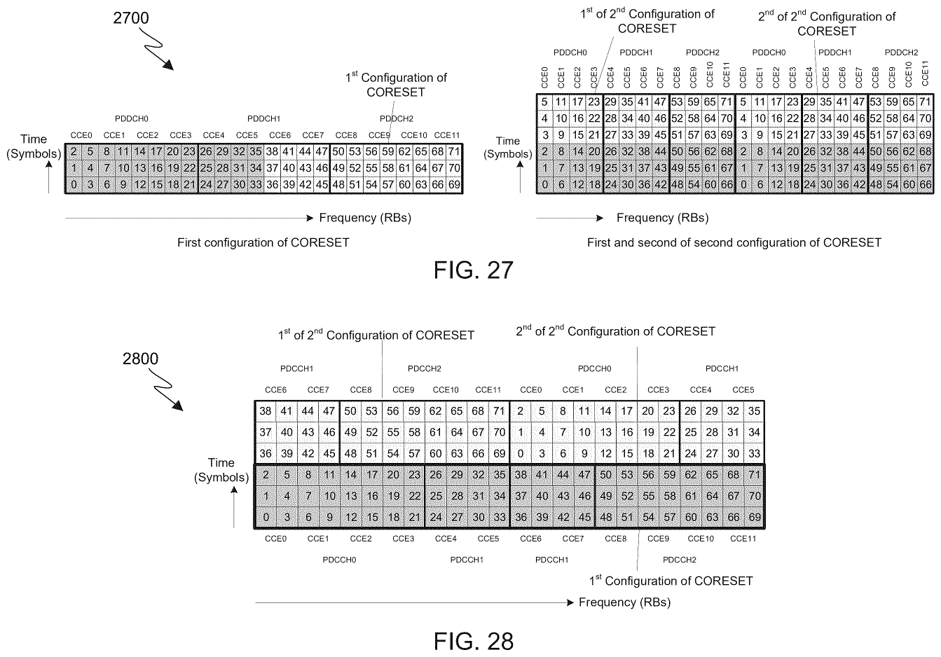

FIG. 27 illustrates an example of PDCCH candidate indexing for multiple sets of resources 2700 for a CORESET according to embodiments of the present disclosure. Once again, as an example, multiple sets of resources 2700 can be implemented by BS 102 of FIG. 1. This example is for illustration only and other embodiments can be used without departing from the scope of the present disclosure.

In one example, the REG numbering or indexing is as illustrated in FIG. 23, L=N=6, and non-interleaved mapping is used for CCE to REG bundle mapping and the CCE indexing is as illustrated in FIG. 30. The PDCCH candidate indexing is as illustrated in FIG. 27, with aggregation level M=4. In the example of FIG. 27, a PDDCH candidate of a first configuration of a CORESET can overlap with 2 PDCCH candidates of a first or second of second configuration of the CORESET. For example, PDDCH 0 of the first configuration of CORESET partially overlaps PDCCH 0 and PDCCH 1 of the first of second configuration of CORESET. For example, PDDCH 2 of the first configuration of CORESET partially overlaps PDCCH 1 and PDCCH 2 of the second of second configuration of CORESET. For example, PDDCH 1 of the first configuration of CORESET partially overlaps PDCCH 2 of the first of second configuration of CORESET and PDCCH 0 of the second of second configuration of CORESET.

FIG. 28 illustrates another example of PDCCH candidate indexing for multiple sets of resources 2800 for a CORESET according to embodiments of the present disclosure. Once again, as an example, multiple sets of resources 2800 can be implemented by BS 102 of FIG. 1. This example is for illustration only and other embodiments can be used without departing from the scope of the present disclosure.

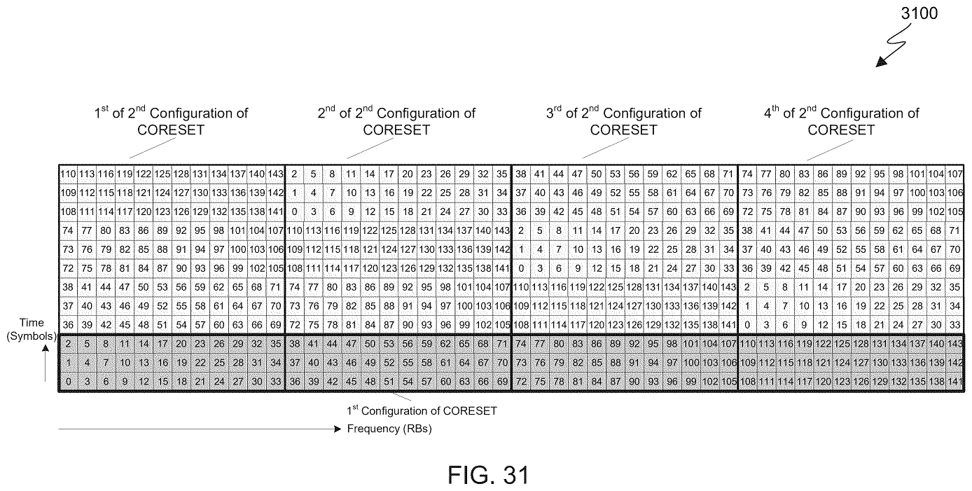

In one example, the REG numbering or indexing is as illustrated in FIG. 24, L=N=6, and non-interleaved mapping is used for CCE to REG bundle mapping and the CCE indexing is as illustrated in FIG. 31. The PDCCH candidate indexing is as illustrated in FIG. 28, with aggregation level M=4. In the example of FIG. 28, the PDCCH numbering for the first configuration of the CORESET and for each of the second configuration(s) of the CORESET is the same in the overlapping region. In one example, some of the CCEs of a PDCCH candidate are common for the first configuration of the CORESET and for the second configuration(s) of the CORESET and some of the CCEs candidate are separate for each configuration of the CORESET. For example, PDCCH1 in FIG. 28, has CCE4 and CCE5 common for the first configuration of the CORESET and the first of the second configuration of the CORESET, while CCE6 and CCE7 are distinct for the first configuration of the CORESET and the first of the second configuration of the CORESET. On the other hand, PDCCH1 in FIG. 28, has CCE6 and CCE7 common for the first configuration of the CORESET and the second of the second configuration of the CORESET, while CCE4 and CCE5 are distinct for the first configuration of the CORESET and the second of the second configuration of the CORESET.

In the examples of FIGS. 25 to 28, non-interleaved REG-to-CCE mapping, and a REG bundle size (L) equal to N, is used for illustration. These examples can be extended to interleaved REG-to CCE mapping and/or bundle size (L) less than N.

In one example, as aforementioned, based on the sub-carrier spacing of the SS/PBCH block and/or the sub-carrier spacing of the CORESET #0 (or the BWP of CORESET #0), the UE determines a table for the set of resource blocks and slot symbols of a CORESET for Type0-PDCCH search space (e.g., CORESET #0 or sub-carrier spacing common), e.g., similar to Tables 2 to 5. In one example, the sub-carrier spacing of the SS/PBCH block is determined by the UE measuring the sub-carrier spacing of the SS/PBCH block. In one example, the sub-carrier spacing of CORESET #0 is provided by the master information block (MIB), e.g., by parameter subCarrierSpacingCommon or similar parameter. In one example, the MIB provides an index for an entry in the table determined by the UE. In one example, the index is a 4-bit value (e.g., from 0 to 15). Based on the indexed provided in the MIB, the UE determines the set of resource blocks and slot symbols for first configuration of CORESET (e.g., CORESET #0) and/or for second configuration of CORESET (e.g., CORESET #0).

In one example, the MIB can include a field, and the field can indicate one of:
The field is 1-bit, and can indicate one of: (a) The resources configured for the CORESET in a cell follow one of the configurations of the CORESET only (e.g., first configuration). (b) The resources configured for the CORESET in a cell follow both configurations of the CORESET. In one example logical value 0 indicates (a) and logical value 1 indicates (b). In one example logical value 0 indicates (b) and logical value 1 indicates (a).
The field is 2-bits, and can indicate one of: (a) The resources configured for the CORESET in a cell follow the first configuration of the CORESET. (a) The resources configured for the CORESET in a cell follow the second configuration of the CORESET. (c) The resources configured for the CORESET in a cell follow both configurations of the CORESET.
In a variant example, first configuration of a CORESET is replaced by first CORESET, and second configuration of a CORESET is replaced by second CORESET.

In one example, the aforementioned field is included in the MIB of UEs of the first Type (e.g., using first configuration of CORESET). In one example, the aforementioned field is included in the MIB of UEs of the second Type (e.g., using second configuration of CORESET).

In one example, the MIB can include a field, and the field can indicate a subset (a subset can also include the full set or an empty set) of the K second set(s) of resources used of the second configuration of the CORESET. In one example, the size of this field can be K bits. In one example, in bit position k starting from the most significant bit (or the least significant bit), a value of 1 indicates the resources k of the second configuration of the CORESET are used, otherwise a value of 0 indicates that the resources k of the second configuration of the CORESET are not used. In one example, in bit position k starting from the most significant bit (or the least significant bit), a value of 0 indicates the resources k of the second configuration of the CORESET are used, otherwise a value of 1 indicates that the resources k of the second configuration of the CORESET are not used. In one example, the aforementioned field is included in the MIB of UEs of the first Type (e.g., using first configuration of CORESET). In one example, the aforementioned field is included in the MIB of UEs of the second Type (e.g., using second configuration of CORESET).

In one example, the MIB can include a field, and the field can indicate one of the K resources of the second configuration of the CORESET. In one example, the size of this field is ┌log₂ K┐. In one example, based on the value of this field, the second UE type can determine the mapping order of the REGs or REG bundles or CCEs or PDCCH candidates as aforementioned. In one example, the aforementioned field is included in the MIB of UEs of the second Type (e.g., using second configuration of CORESET).

In one example, a UE can be indicated by a field in a DCI Format, one of the following:
The field is 1-bit, and can indicate one of: (a) The resources configured for the CORESET in a slot or monitoring occasion (MO) follow one of the configurations of the CORESET only (e.g., first configuration or the configuration corresponding to the UE type receiving the DCI Format). (b) The resources configured for the CORESET in a slot/MO follow both configurations of the CORESET. In one example logical value 0 indicates (a) and logical value 1 indicates (b). In one example logical value 0 indicates (b) and logical value 1 indicates (a). In various embodiments, the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot/MO of the DCI format until a next slot/MO after a slot/MO with a second DCI format that includes the field. (8) All slots/MOs (e.g. of the CORESET) from next DL slot/MO after the slot/MO of the DCI format until a next DL slot/MO after a slot with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.
The field is 2-bits, and can indicate one of: (a) The resources configured for the CORESET in a slot/MO follow the first configuration of the CORESET. (a) The resources configured for the CORESET in a slot/MO follow the second configuration of the CORESET. (c) The resources configured for the CORESET in a slot/MO follow both configurations of the CORESET. In a variant example, a code point of the 2-bit field can additionally indicate that the resources configured for both configurations of the CORESET in a slot/MO are not used for PDCCH (e.g., available for other channels and signals such as PDSCH or PUSCH). In various embodiments, the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot/MO of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot of the DCI format until a next slot/MO after a slot/MO with a second DCI format that includes the field. (8) All slots/MOs (e.g. of the CORESET) from next DL slot/MO after the slot/MO of the DCI format until a next DL slot/MO after a slot/MO with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.

In one example, the aforementioned field is included in a DCI Format of UEs of the first Type (e.g., using first configuration of CORESET or first CORESET). In one example, the aforementioned field is included in a DCI Format of UEs of the second Type (e.g., using second configuration of CORESET or second CORESET).

In one example, a UE can be indicated by a field in a DCI Format a subset (a subset can also include the full set or an empty set) of the K second set(s) of resources used of the second configuration of the CORESET in a slot or monitoring occasion (MO). In one example, the size of this field can be K bits. In one example, in bit position k starting from the most significant bit (or the least significant bit), a value of 1 indicates the resources k of the second configuration of the CORESET are used in the slot or MO, otherwise a value of 0 indicates that the resources k of the second configuration of the CORESET are not used in the slot or MO. In one example, in bit position k starting from the most significant bit (or the least significant bit), a value of 0 indicates the resources k of the second configuration of the CORESET are used in the slot or MO, otherwise a value of 1 indicates that the resources k of the second configuration of the CORESET are not used in the slot or MO.

In one example, a UE can be indicated by a field in a DCI Format a subset (a subset can also include the full set or an empty set) of the K second set(s) of resources used of the second configuration of the CORESET in a slot or monitoring occasion (MO) and whether the first configuration of the CORESET is used in the slot/MO. In one example, the size of this field can be K+1 bits. In one example, in bit position k or k+1 starting from the most significant bit (or the least significant bit), a value of 1 indicates the resources k of the second configuration of the CORESET are used in the slot or MO, otherwise a value of 0 indicates that the resources k of the second configuration of the CORESET are not used in the slot or MO. In one example, in bit position k or k+1 starting from the most significant bit (or the least significant bit), a value of 0 indicates the resources k of the second configuration of the CORESET are used in the slot or MO, otherwise a value of 1 indicates that the resources k of the second configuration of the CORESET are not used in the slot or MO. In one example, the most significant bit (or the least significant bit) can indicate whether the resources of the first configuration of the CORESET are used in the sot/MO, wherein a value of 1 can indicate that the resources of the first configuration of the CORESET are used in the slot/MO and a value of 0 can indicate that the resources of the first configuration of the CORESET are not used in the slot/MO and vice versa.

In various embodiments, the slot/MO can be one of: (1) The slot/MO of the DCI format. (2) the next slot/MO after the slot/MO of the DCI Format. (3) The next DL slot/MO after the slot/MO of the DCI Format. (4) A slot/MO at an offset n slots/MOs from the slot/MO of the DCI format, where the offset n can be defined in the system specification and/or configured or updated by RRC and/or MAC and/or L1 control (e.g., DCI Format) signaling. (5) A slot/MO at an offset n slots/MOs from the slot of the DCI format, where the offset n can be provided by the DCI format. (6) All slots/MOs (e.g. of the CORESET) from the slot/MO of DCI format until a slot/MO with a second DCI format that includes the field. (7) All slots/MOs (e.g. of the CORESET) from next slot/MO after the slot/MO of the DCI format until a next slot/MO after a slot/MO with a second DCI format that includes the field. (8) All slots/MOs (e.g. of the CORESET) from next DL slot/MO after the slot/MO of the DCI format until a next DL slot/MO after a slot with a second DCI format that includes the field. (9) All slots/MOs (e.g. of the CORESET) starting n slots/MOs after the slot/MO of the DCI format until a slot/MO starting n slots/MOs after a slot/MO with a second DCI format that includes the field, wherein n can be provided as aforementioned. (10) The slot/MO of a PDSCH and/or PUSCH being scheduled by the DCI format.

In one example, the aforementioned field is included in the MIB of UEs of the first Type (e.g., using first configuration of CORESET or first CORESET). In one example, the aforementioned field is included in the MIB of UEs of the second Type (e.g., using second configuration of CORESET or second CORESET).

In one example, a UE (e.g., UE of a second Type) one of the K resources of the second configuration of the CORESET to use in a slot or MO. In one example, the size of this field is ┌log₂ K┐. In one example, based on the value of this field, the second UE type can determine the mapping order of the REGs or REG bundles or CCEs or PDCCH candidates as aforementioned in the slot or MO. In one example, the aforementioned field is included in a DCI Format of UEs of the second Type (e.g., using second configuration of CORESET). In one example, the slot or MO can be determined as aforementioned in this disclosure.

Based on the resources indicated by the DCI Format (e.g., resources of one configuration or both configurations of a CORESET), the UE (e.g., UE of a first type) can rate match a PDSCH transmission or a PUSCH transmission around the resources used for the indicated configuration(s) of the CORESET.

FIG. 29 illustrates examples of a DCI format 2900 indicating configuration of the CORESET of a slot according to embodiments of the present disclosure. For example, DCI format 2900 can be utilized by BS 102 of FIG. 1. This example is for illustration only and other embodiments can be used without departing from the scope of the present disclosure.

In one example, the DCI Format can be DL related DCI Format, e.g., similar to DCI Format 1_1 or DCI Format 1_2 in NR. In one example, a DCI Format can be a UE common DCI Format (e.g., received by UEs of a certain type) using a group common RNTI. In the example of FIG. 29, K=2, i.e., there are two second configurations. In one example, the size of the field is K bits and the field can indicate whether or not a k resource set of the second configuration of the CORESET is used or not as aforementioned. In one example the size of the field is K+1 bits, and the field can indicate whether or not a k resource set of the second configuration of the CORESET is used or not, and whether or not the resource set of the first configuration of the CORESET is used or not. In a variant example, a DCI Format can be replaced by a sequence-based signal, wherein a sequence indicates a CORESET configuration (or a CORESET to use).

As illustrated in FIG. 29, DCI format 2900 is transmitted indicating that in slot n1, resources are used for the first of the second configuration of the CORESET (and the first configuration of the CORESET). A PDSCH is transmitted in slot n1 is rate matched around the resources used of the CORESET. Further, DCI format 2900 is transmitted indicating that in slot n2, resources are used for the second of the second configuration of the CORESET (and the first configuration of the CORESET). A PDSCH is transmitted in slot n2 is rate matched around the resources used of the CORESET.

In one example, rate-matching patterns are defined to include one or more of:
A rate matching pattern for resources of first configuration of the CORESET (or first CORESET).
A rate matching pattern for resources of one or more of the K resources set of second configuration of the CORESET (or K second CORESETs).
A rate matching pattern for resources first configuration of the CORESET (or first CORESET) and one or more of the K resources set of second configuration of the CORESET (or K second CORESETs).
A rate matching pattern for resources of configuration of the CORESET (or CORESET) corresponding to the UE type.

In one example, rate-matching patterns are defined to include one or more of:
A rate matching pattern for resources of first configuration of the CORESET (or first CORESET).
A rate matching pattern for resources of one or more resource sets of second configuration of the CORESET (or second CORESETs).
A rate matching pattern for resources of first configuration of the CORESET (or first CORESET) and of one or more resource sets of second configuration of the CORESET (or second CORESETs).
A rate matching pattern for resources of configuration of the CORESET (or CORESET) corresponding to the UE type.

In various embodiments, each rate matching pattern can correspond to an ID, other IDs can correspond to other rate matching patterns. In one example, the rate matching pattern is for the resources around which PDSCH is rate matched. In one example, the rate matching pattern ID is indicated in a DCI format as previously mentioned. In one example the rate matching pattern can apply to a slot or a monitoring occasion (MO), wherein, the slot or MO can be determined as aforementioned in this disclosure.

The aforementioned examples can be extended to multiple sets of UEs for multiple UE types. In one example, the controlResourceSetZero provided by the MIB can indicate multiple sets of resources for a CORESET, a first set of resources for a first configuration of a CORESET and K2 second sets of resources for K2 of a second configuration of the CORESET, and K3 second sets of resources for K3 of a third configuration of the CORESET, . . . and KP Pth sets of resources for KP of a Pth configuration of the CORESET. In the following, without loss of generality, it is assumed that

$${N}_{RB P}^{CORESET} … \leq {N}_{RB 2}^{CORESET} \leq {N}_{RB 1}^{CORESET} .$$

A first set of resources

$${N}_{symb 1}^{CORESET} \times {N}_{RB 1}^{CORESET}$$

starting at

$${N}_{start 1}^{CORESET} ,$$

for a first type or group of users (e.g., standard users with a large bandwidth), wherein

$${N}_{symb 1}^{CORESET}$$

is the duration of the first configuration of the CORESET in time units (e.g., symbols),

$${N}_{RB 1}^{CORESET}$$

is the frequency span of the first configuration of the CORESET in frequency units (e.g., resource blocks (RBs)), and

$${N}_{start 1}^{CORESET}$$

is the starting location of the first configuration of the CORESET in frequency units (e.g., sub-carriers and/or RBs).
A second set(s) of resources

$${N}_{symb 2}^{CORESET} \times {N}_{RB 2}^{CORESET}$$

starting at

$${N}_{start 2 - k 2}^{CORESET} ,$$

where k2=0, 1, . . . . K2−1, for a second type of users (e.g., low bandwidth users), wherein

$${N}_{symb 2}^{CORESET}$$

is the duration of the second configuration of the CORESET in time units (e.g., symbols),

$${N}_{RB 2}^{CORESET}$$

is the frequency span of the first configuration of the CORESET in frequency units (e.g., resource blocks (RBs)). There are K2 second set(s) of resources, wherein the (k2+1)th second set of resources starts at

$${N}_{start 2 - k 2}^{CORESET} , and {N}_{start 2 - k 2}^{CORESET}$$

is in frequency units (e.g., sub-carriers and/or RBs).
. . .
A Pth set(s) of resources

$${N}_{symb P}^{CORESET} \times {N}_{RB P}^{CORESET}$$

starting at

$${N}_{start P - k P}^{CORESET} ,$$

where kP=0,1, . . . . KP−1, for a Pth type of users (e.g., even lower bandwidth users), wherein

$${N}_{symb P}^{CORESET}$$

is the duration of the second configuration of the CORESET in time units (e.g., symbols),

$${N}_{RB P}^{CORESET}$$

is the frequency span of the first configuration of the CORESET in frequency units (e.g., resource blocks (RBs)). There are KP Pth set(s) of resources, wherein the (kP+1)th second set of resources starts at

$${N}_{startP - k P}^{CORESET} , and {N}_{startP - k P}^{CORESET}$$

is in frequency units (e.g., sub-carriers and/or RBs).
In a variant example, an nth configuration of a CORESET is replaced by a configuration of an nth CORESET. In a variant example, pth resources of a nth configuration of a CORESET, is replaced configuration of (n,p) CORESET.

In one example, having Ki second set(s) for resources for the ith type of users allows the distribution of the ith type of users among the Ki ith set(s) of resources, where i=2, 3, . . . , P. In one example, a subset (a subset can also include the full set or an empty set) of the Ki ith set(s) of resources is used, wherein the subset can be indicated or signaled to the users of the cell (e.g., to the first type of users). In one example, this signaling can allow the signaled users to determine the resources to use or the resources to avoid (e.g., rate match around) when transmitting to/from the network.

In one example,

$${N}_{start i - k}^{CORESET}$$

is selected such the Ki second set(s) of resources don't overlap. In one example,

$${N}_{start i - k i}^{CORESET}$$

is selected such the Ki ith set(s) of resources are adjacent to each other. In one example,

$${N}_{start i - k i}^{CORESET} = {N}_{start i - 0}^{CORESET} + k i * {N}_{RB i}^{CORESET} .$$

In one example,

$${N}_{start}^{CORESET} = {N}_{start i - 0}^{CORESET} = {N}_{start 1}^{CORESET} ,$$

i.e., the first configuration of the CORESET and the first, second, . . . . Pth configuration of the CORESET have a same starting location. In one example, the first configuration of the CORESET and each of the Ki ith configuration(s) of the CORESET overlap in the following resources,

$$min ( {N}_{symb 1}^{CORESET} , {N}_{symb i}^{CORESET} ) \times min ( {N}_{R B 1}^{CORESET} , {N}_{RB i}^{CORESET} ) .$$

Where i=2, 3, . . . , P.

FIG. 30 illustrates another example of multiple sets of resources 3000 for a CORESET according to embodiments of the present disclosure. More particularly, FIG. 30 illustrates a first set of resources for a first configuration of a CORESET, K2 second sets of resources for K2 of a second configuration of the CORESET, and K3 third sets of resources for K3 of a third configuration of the CORESET. For example, multiple sets of resources 3000 can be implemented by BS 102 of FIG. 1. These examples are for illustration only and other embodiments can be used without departing from the scope of the present disclosure.

As illustrated in FIG. 30, multiple sets of resources 3000, where P=3, K2=2 and K3=4 is provided.
In FIG. 30, a CORESET has a first configuration of the CORESET of size 3 symbols×48 RBs, and
a first of second configuration of the CORESET of size 6 symbols×24 RBs, starting at the same RB as the first configuration of the CORESET, and a second of second configuration of the CORESET of size 6 symbols×24 RBs, starting at an offset of 24 RBs from the starting RB of the first configuration of the CORESET, and
a first of third configuration of the CORESET of size 12 symbols×12 RBs, starting at the same RB as the first configuration of the CORESET, and a second of third configuration of the CORESET of size 12 symbols×12 RBs, starting at an offset of 12 RBs from the starting RB of the first configuration of the CORESET, and a third of third configuration of the CORESET of size 12 symbols×12 RBs, starting at an offset of 24 RBs from the starting RB of the first configuration of the CORESET, and a fourth of third configuration of the CORESET of size 12 symbols×12 RBs, starting at an offset of 12 RBs from the starting RB of the first configuration of the CORESET.

Further in the example of FIG. 30:
The first configuration of the CORESET and each of the second configurations of the CORESET overlap in 6 symbols×24 RBs.
The first configuration of the CORESET and each of the third configurations of the CORESET overlap in 3 symbols×12 RBs.
A second configuration of the CORESET and a third configuration of the CORESET, if they overlap, they overlap in 3 symbols×12 RBs.

In the following, the present disclosure provides examples of how REGs can be indexed for different configurations of a CORESET:
A first set of resources

$${N}_{symb 1}^{CORESET} \times {N}_{R B 1}^{CORESET}$$

starting at

$${N}_{start 1}^{CORESET} ,$$

wherein

$${N}_{symb 1}^{CORESET}$$

is the duration of the first configuration of the CORESET in time units (e.g., symbols),

$${N}_{RB 1}^{CORESET}$$

is the frequency span of the first configuration of the CORESET in frequency units (e.g., resource blocks (RBs)), and

$${N}_{start 1}^{CORESET}$$

is the starting location of the first configuration of the CORESET in frequency units (e.g., sub-carriers and/or RBs).
A second set(s) of resources

$${N}_{s y m b 2}^{CORESET} \times {N}_{R B 2}^{CORESET}$$

starting at

$${N}_{start 2 - k}^{CORESET} ,$$

where k=0, 1, . . . K−1, wherein

$${N}_{symb 2}^{CORESET}$$

is the duration of the second configuration of the CORESET in time units (e.g., symbols),

$${N}_{R B 2}^{CORESET}$$

is the frequency span of the first configuration of the CORESET in frequency units (e.g., resource blocks (RBs)). There are K second set(s) of resources, wherein the (k+1)th second set of resources starts at

$${N}_{s t a r t 2 - k}^{CORESET} , and {N}_{s t a r t 2 - k}^{CORESET}$$

is in frequency units (e.g., sub-carriers and/or RBs). In one example,

$${N}_{start 2 - k}^{CORESET}$$

is selected such the K second set(s) of resources don't overlap. In one example,

$${N}_{start 2 - k}^{CORESET}$$

is selected such the K second set(s) of resources are adjacent to each other. In one example,

$${N}_{start 2 - k}^{CORESET} = {N}_{start 2 - 0}^{CORESET} + k * {N}_{RB 2}^{CORESET} .$$

In one example,

$${N}_{start}^{CORESET} = {N}_{start 2 - 0}^{CORESET} = {N}_{start 1}^{CORESET} ,$$

i.e., the first configuration of the CORESET and the first, second configuration of the CORESET have a same starting location.

In the following examples:

$${N}_{R B 1}^{CORESET} = A \cdot {N}_{R B 2}^{CORESET} and {N}_{s y m b 2}^{CORESET} = A \cdot {N}_{s y m b 1}^{CORESET} .$$

In some examples, A is an integer. In some examples, A is a power of 2.

In one example, for a first configuration of CORESET, the RB with the smallest index is r=0 and the symbol with the smallest index is s=0. A REG with index i corresponds to RB r and symbol s within the first configuration of the CORESET, wherein:

$$r = ⌊ \frac{i}{{N}_{symb 1}^{CORESET}} ⌋ ;$$

$$s = i \% {N}_{symb 1}^{CORESET} .$$

For a k resource set of the second configuration of the CORESET a REG with index i corresponds to RB r and symbol s within the first configuration of the CORESET, or corresponds to RB rₖ and symbol sₖ with the kth of the second configuration of the CORESET:
Let

$$q = ⌊ ⌊ \frac{i}{{N}_{s y m b 1}^{CORESET}} ⌋ / {N}_{R B 2}^{CORESET} ⌋ ;$$

If q=k,

$$r = ⌊ \frac{i}{{N}_{s y m b 1}^{C O R E S E T}} ⌋$$

$$s = i \% {N}_{s y m b 1}^{C O R E S E T}$$

$${r}_{k} = r - k \times {N}_{R B 2}^{C O R E S E T}$$

$${s}_{k} = s$$

End if,
   For any value of q, this disclosure can have:

$$r = k \times {N}_{R B 2}^{C O R E S E T} + ( ⌊ \frac{i}{{N}_{s y m b 1}^{C O R E S E T}} ⌋ \% {N}_{R B 2}^{C O R E S E T} )$$

$$s = ( ( q - r ) \% A ) \times {N}_{s y m b 1}^{C O R E S E T} + ( i \% {N}_{s y m b 1}^{C O R E S E T} )$$

Alternatively:

$$s = ( ( r - q ) \% A ) \times {N}_{s y m b 1}^{C O R E S E T} + ( i \% {N}_{s y m b 1}^{C O R E S E T} )$$

$${r}_{k} = r - k \times {N}_{R B 2}^{C O R E S E T}$$

$${s}_{k} = s$$

FIG. 31 illustrates an example of REG indexing for multiple sets of resources 3100 for a CORESET according to embodiments of the present disclosure. Once again, as an example, multiple sets of resources 3100 can be implemented by BS 102 of FIG. 1. This example is for illustration only and other embodiments can be used without departing from the scope of the present disclosure.

More particularly, FIG. 31 illustrates an example of indexing of REGs for with

$${N}_{symb 1}^{C O R E S E T} = 3 , {N}_{RB 1}^{C O R E S E T} = 48 , {N}_{s y m b 2}^{C O R E S E T} = 12 , {N}_{R B 2}^{C O R E S E T} = 12 ,$$

and A=4. The first equation of s is used.

In one example, for a first configuration of CORESET, the RB with the smallest index is r=0 and the symbol with the smallest index is s=0. A REG with index i corresponds to RB r and symbol s within the first configuration of the CORESET, wherein:

$$r = ⌊ \frac{i}{{N}_{s y m b 1}^{C O R E S E T}} ⌋ ;$$

$$s = i \% {N}_{s y m b 1}^{C O R E S E T} .$$

For a k resource set of the second configuration of the CORESET a REG with index i corresponds to RB r and symbol s within the first configuration of the CORESET, or corresponds to RB rₖ and symbol sₖ with the kth of the second configuration of the CORESET:
Let

$$q = ⌊ ⌊ \frac{i}{{N}_{s y m b 1}^{C O R E S E T}} ⌋ / {N}_{R B 2}^{C O R E S E T} ⌋ ,$$

and qᵣ=Revₖ(q), where, the output of function Rev_{K}( ), is the reverse binary representation of the input and the input is represented as a K bit number. For example, if K=2, 1 is represented as Olin binary, the reverse binary is 10, which is 2, therefore, Rev₂(1)=2. Similarly, 2 is represented as 10 in binary, the reverse binary is 01, which is 1, therefore, Rev₂(2)=1.
In one example, K=log₂ A.
If q==k,

$$r = ⌊ \frac{i}{{N}_{s y m b 1}^{C O R E S E T}} ⌋$$

$$s = i \% {N}_{s y m b 1}^{C O R E S E T}$$

$${r}_{k} = r - k \times {N}_{R B 2}^{C O R E S E T}$$

$${s}_{k} = s$$

End if,
   For any value of q, this disclosure can have:

$$r = k \times {N}_{RB 2}^{CORESET} + ( ⌊ \frac{i}{{N}_{symb 1}^{CORESET}} ⌋ \% {N}_{RB 2}^{CORESET} )$$

$$s = {Rev}_{K} ( q ⊕ k ) \times {N}_{symb 1}^{CORESET} + ( i \% {N}_{symb 1}^{CORESET} )$$

$${r}_{k} = r - k \times {N}_{RB 2}^{CORESET}$$

$${s}_{k} = s$$

where, ⊕ is a bitwise XOR operator.

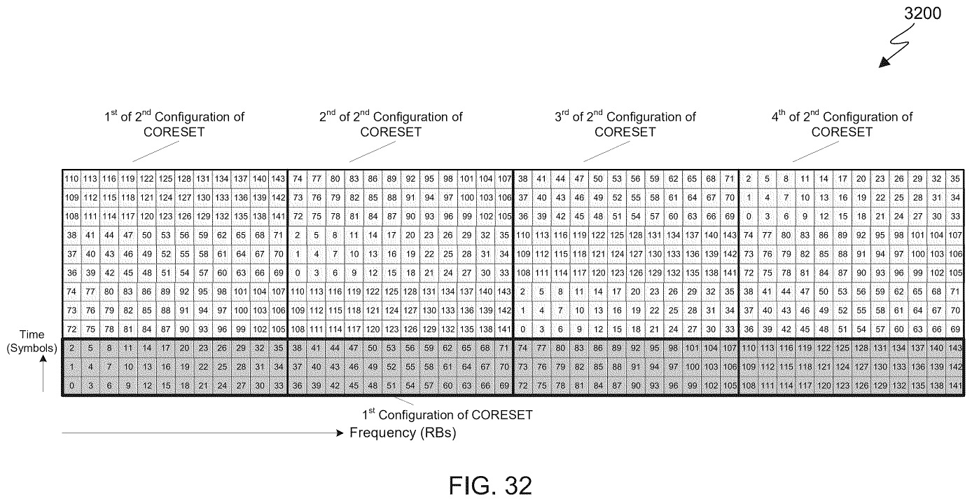

FIG. 32 illustrates another example of REG indexing for multiple sets of resources 3200 for a CORESET according to embodiments of the present disclosure. Once again, as an example, multiple sets of resources 3200 can be implemented by BS 102 of FIG. 1. This example is for illustration only and other embodiments can be used without departing from the scope of the present disclosure.

More particularly, FIG. 32 illustrates an example of indexing of REGs for with

$${N}_{symb 1}^{CORESET} = 3 , {N}_{RB 1}^{CORESET} = 48 , {N}_{symb 2}^{CORESET} = 12 , {N}_{RB 2}^{CORESET} = 12 ,$$

### and A=4.

In the examples of this disclosure, after a set of REs is identified for a PDCCH candidate, the coded modulation symbols corresponding to the PDCCH candidate are mapped to the identified REs first in order of frequency, then in order of time. In a variant example, the coded modulation symbols corresponding to the PDCCH candidate are mapped to the identified REs first in order of time, then in order of frequency.

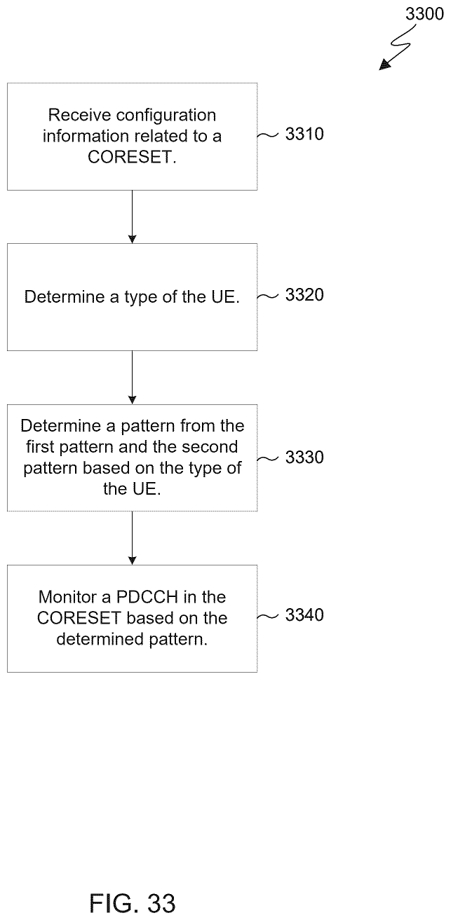

FIG. 33 illustrates an example method 3300 performed by UE in a wireless communication system according to embodiments of the present disclosure. The method 3300 of FIG. 33 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3300 is for illustration only and other embodiments can be used without departing from the scope of the present disclosure.

The method 3300 begins with the UE receiving configuration information related to a CORESET (3310). For example, in 3310, The configuration information includes a first pattern and a second pattern. The first pattern spans

$${N}_{symb 1}^{CORESET}$$

symbols and

$${N}_{RB 1}^{CORESET}$$

RBS. The second pattern spans

$${N}_{symb 2}^{CORESET}$$

symbols and

$${N}_{RB 2}^{CORESET}$$

### RBS.

$${N}_{symb 1}^{CORESET} < {N}_{symb 2}^{CORESET} and$$

$${N}_{RB 1}^{CORESET} > {N}_{RB 2}^{CORESET} .$$

The first pattern and the second pattern overlaps over the

$${N}_{symb 1}^{CORESET}$$

symbols and the

$${N}_{RB 2}^{CORESET}$$

RBs. The CORESET corresponds to a CORESET zero. The CORESET zero is used by the UE to monitor PDCCH channels with first DCI scheduling a SIB1. In various embodiments, the configuration information is included in a MIB.

The UE then determines a type of the UE (3320). The UE then determines a pattern from the first pattern and the second pattern based on the type of the UE (3330). The UE then monitors a PDCCH in the CORESET based on the determined pattern (3340).

In various embodiments, the UE receives, via second DCI, a flag indicating whether non-overlapping resources of another one of the first pattern and the second pattern are available for transmission of a PDSCH in a slot associated with the second DCI. The flag is included in the second DCI scheduling the PDSCH. The slot is a slot of reception of the PDSCH. The slot is T slots after the slot with the second DCI. In various embodiments, in the overlapping region of pattern 1 and pattern 2, a CCE of pattern 1, has a same index as the overlapping CCE of pattern 2.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive configuration information related to a control resource set (CORESET), wherein:
the configuration information includes a first pattern and a second pattern,
the first pattern spans
$${N}_{symb 1}^{CORESET}$$
symbols and
$${N}_{RB 1}^{CORESET}$$
resource blocks (KBS),
the second pattern spans
$${N}_{symb 2}^{CORESET}$$
symbols and
$${N}_{RB 2}^{CORESET}$$
RBS,
$${N}_{symb 1}^{CORESET} < {N}_{symb 2}^{CORESET} and$$
$${N}_{RB 1}^{CORESET} > {N}_{RB 2}^{CORESET} ,$$
and
the first pattern and the second pattern overlap over the
$${N}_{symb 1}^{CORESET}$$
symbols and the
$${N}_{RB 2}^{CORESET}$$
RBs; and
a processor operably coupled to the transceiver, the processor configured to:
determine a type of the UE,
determine, based on the type of the UE, a pattern from the first pattern and the second pattern, and
monitor a PDCCH in the CORESET based on the determined pattern.

2. The UE of claim 1, wherein the configuration information is included in a master information block (MIB).

3. The UE of claim 1, wherein the transceiver is further configured to receive, via second DCI, a flag indicating whether non-overlapping resources of another one of the first pattern and the second pattern are available for transmission of a physical downlink shared channel (PDSCH) in a slot associated with the second DCI.

4. The UE of claim 3, wherein:
the flag is included in the second DCI scheduling the PDSCH, and
the slot is a slot of reception of the PDSCH.

5. The UE of claim 3, wherein the slot is T slots after the slot with the second DCI.

6. The UE of claim 1, wherein:
the CORESET corresponds to a CORESET zero, and
the CORESET zero is used by the UE to monitor physical downlink control channel (PDCCH) channels with first downlink control information (DCI) scheduling a system information block 1 (SIB1).

7. The UE of claim 1, wherein, in the overlapping region of pattern 1 and pattern 2, a control channel element (CCE) of pattern 1, has a same index as the overlapping CCE of pattern 2.

8. A base station (BS) comprising:
a transceiver configured to transmit configuration information related to a control resource set (CORESET), wherein:
the configuration information includes a first pattern and a second pattern,
the first pattern spans
$${N}_{symb 1}^{CORESET}$$
symbols and
$${N}_{RB 1}^{CORESET}$$
resource blocks (RBs),
the second pattern spans
$${N}_{symb 2}^{CORESET}$$
symbols and
$${N}_{RB 2}^{CORESET}$$
RBS,
$${N}_{symb 1}^{CORESET} < {N}_{symb 2}^{CORESET} and {N}_{RB 1}^{CORESET} > {N}_{RB 2}^{CORESET} ,$$
and
the first pattern and the second pattern overlaps over the
$${N}_{symb 1}^{CORESET}$$
symbols and the
$${N}_{RB 2}^{CORESET}$$
RBs; and
a processor operably coupled to the transceiver, the processor configured to:
determine a type of the UE, and
determine, based on the type of the UE, a pattern from the first pattern and the second pattern,
wherein the transceiver is further configured to transmit a PDCCH in the CORESET based on the determined pattern.

9. The BS of claim 8, wherein the configuration information is included in a master information block (MIB).

10. The BS of claim 8, wherein the transceiver is further configured to transmit, via second DCI, a flag indicating whether non-overlapping resources of another one of the first pattern and the second pattern are available for transmission of a physical downlink shared channel (PDSCH) in a slot associated with the DCI.

11. The BS of claim 10 wherein:
the flag is included in the second DCI scheduling the PDSCH, and
the slot is a slot of transmission of the PDSCH.

12. The BS of claim 10, wherein the slot is T slots after the slot with the second DCI.

13. The BS of claim 8, wherein:
the CORESET corresponds to a CORESET zero, and
the CORESET zero is used by a user equipment (UE) to monitor physical downlink control channel (PDCCH) channels with first downlink control information (DCI) scheduling a system information block 1 (SIB1).

14. A method of operating a user equipment (UE), the method comprising:
receiving configuration information related to a control resource set (CORESET), wherein:
the configuration information includes a first pattern and a second pattern,
the first pattern spans
$${N}_{symb 1}^{CORESET}$$
symbols and
$${N}_{RB 1}^{CORESET}$$
resource blocks (RBS),
the second pattern spans
$${N}_{symb 2}^{CORESET}$$
symbols and
$${N}_{RB 2}^{CORESET}$$
RBS,
$${N}_{symb 1}^{CORESET} < {N}_{symb 2}^{CORESET} and {N}_{RB 1}^{CORESET} > {N}_{RB 2}^{CORESET} ,$$
and
the first pattern and the second pattern overlaps over the
$${N}_{symb 1}^{CORESET}$$
symbols and the
$${N}_{RB 2}^{CORESET}$$
RBs;
determining a type of the UE;
determining, based on the type of the UE, a pattern from the first pattern and the second pattern; and
monitoring a PDCCH in the CORESET based on the determined pattern.

15. The method of claim 14, wherein the configuration information is included in a master information block (MIB).

16. The method of claim 14, further comprising receiving, via second DCI, a flag indicating whether non-overlapping resources of another one of the first pattern and the second pattern are available for transmission of a physical downlink shared channel (PDSCH) in a slot associated with the second DCI.

17. The method of claim 16, wherein:
the flag is included in the second DCI scheduling the PDSCH, and
the slot is a slot of reception of the PDSCH.

18. The method of claim 16, wherein the slot is T slots after the slot with the second DCI.

19. The method of claim 14, wherein:
the CORESET corresponds to a CORESET zero, and
the CORESET zero is used by the UE to monitor physical downlink control channel (PDCCH) channels with first downlink control information (DCI) scheduling a system information block 1 (SIB1).

20. The method of claim 14, wherein, in the overlapping region of pattern 1 and pattern 2, a control channel element (CCE) of pattern 1, has a same index as the overlapping CCE of pattern 2.
